(19) United States
(12) Patent Application Publication
(10) Pub. No.: US 2016/0166962 A1
(43) Pub. Date: Jun. 16, 2016

(54) FINE GLASS FILTER MEDIA

(71) Applicant: Hollingsworth & Vose Company, East Walpole, MA (US)

(72) Inventors: David F. Sealey, Worcestershire (GB); Sudhakar Jaganathan, Waltham, MA (US); Randall B. Keisler, Clifton Park, NY (US); David Vallery, Amherst, NH (US)

(73) Assignee: Hollingsworth & Vose Company, East Walpole, MA (US)

(21) Appl. No.: 14/966,608

(22) Filed: Dec. 11, 2015

Related U.S. Application Data
(62) Division of application No. 14/097,493, filed on Dec. 5, 2013.

(51) Int. Cl. B01D 39/20

(52) U.S. Cl. CPC B01D 39/2024; B01D 39/2017

(57) ABSTRACT

Filter media suitable for various applications and related components, systems, and methods associated therewith are described. The filter media may include a composite filter media structure having a substrate and at least one fine fiber layer. The fine fiber layer may include a plurality of glass fibers having an average fiber diameter of less than 2 microns; or, at least 70% by weight of the glass fibers within the fine fiber layer has a fiber diameter of less than 2 microns. The fine fiber layer may further include a fluorochemical composition, an organosilicon composition and may optionally include a binder composition that comprises less than 2% by weight of the fine fiber layer. The filter media may exhibit both a relatively high gamma and favorable mechanical properties. The filter media may be produced by forming a substrate on the surface of a wire in a wet laid process, and forming a fine fiber layer on the substrate while the substrate is on the wire.

### RELATED APPLICATIONS

This application is a divisional of U.S. application Ser. No. 14/097,493 filed Dec. 3, 2015, which is incorporated herein by reference in its entirety.

### FIELD OF INVENTION

Aspects described herein relate generally to filter media having enhanced filtration properties.

### BACKGROUND

Various filter media can be used to remove contamination in a number of applications. Filter media may be designed to have different performance characteristics, depending on their desired use. For example, relatively lower efficiency filter media may be used for heating, ventilating, refrigerating, air conditioning applications. For applications that demand different performance characteristics (e.g., very high efficiency), such as for clean rooms or biomedical applications, high efficiency particulate air (HEPA) or ultra low penetration air (ULPA) filters may be used.

Filter media can be formed of one or more fiber webs. A fiber web provides a porous structure that permits fluid (e.g., gas, air) to flow through the filter media. Contaminant particles contained within the fluid may be trapped on or within the fibrous web. Filter media characteristics, such as surface area and basis weight, affect filter performance including filter efficiency, pressure drop and resistance to fluid flow through the filter. In general, higher filter efficiencies may result in a higher resistance to fluid flow which leads to higher pressure drops for a given flow rate across the filter.

There is a need for filter media that can be used in a variety of applications which have a desirable balance of properties including a high efficiency and a low resistance to fluid flow across the filter media, leading to high gamma values.

### SUMMARY

Filter media suitable for various applications, and related components, systems, and methods associated therewith are provided.

In an illustrative embodiment, a filter media is provided. The filter media includes a substrate; a first layer comprising a plurality of glass fibers, wherein at least 70% by weight of the plurality of glass fibers within the first layer have a fiber diameter of less than 2 microns; and a second layer comprising a plurality of glass fibers, wherein at least 70% by weight of the plurality of glass fibers within the second layer have a fiber diameter of less than 2 microns.

In another illustrative embodiment, a filter media is provided. The filter media includes a substrate; a first layer comprising a plurality of glass fibers having an average fiber diameter of less than 2 microns; and a second layer comprising a plurality of glass fibers having an average fiber diameter of less than 2 microns.

In a further illustrative embodiment a filter media is provided. The filter media includes a substrate; and at least one layer comprising a fluorochemical composition, an organosilicon composition and a plurality of glass fibers, wherein at least 70% by weight of the plurality of glass fibers within the at least one layer have a fiber diameter of less than 2 microns, the at least one layer optionally including a binder composition, wherein the binder composition comprises between 0% and 2% by weight of the at least one layer.

In yet another illustrative embodiment, a method of manufacturing a filter media is provided. The filter media includes disposing, through a wet laid process, a first mixture, containing a plurality of fibers in a first solvent, onto a surface to form a substrate; while the substrate is on the surface, disposing a second mixture, containing a plurality of glass fibers in a second solvent, onto the substrate to form at least one layer, wherein at least 70% by weight of the plurality of glass fibers within the at least one layer have a fiber diameter of less than 2 microns; at least partially removing the first solvent from the first mixture; and at least partially removing the second solvent from the second mixture.

In an illustrative embodiment, a filter media is provided. The filter media includes a substrate; and at least one layer comprising a plurality of glass fibers; wherein the filter media exhibits a gamma of greater than 12 and a machine direction tensile strength of greater than 3.0 lbs/inch.

In another illustrative embodiment, a filter media is provided. The filter media includes a substrate; and at least one layer comprising a plurality of glass fibers; wherein the filter media exhibits a gamma of greater than 12 and a stiffness of greater than 400 gu.

The foregoing is a non-limiting summary of the invention, which is defined by the attached claims. Other aspects, embodiments, features and advantages will become apparent from the following description. Each reference incorporated herein by reference is incorporated in its entirety. In cases of conflict or inconsistency between an incorporated reference and the present specification, the present specification will control.

### BRIEF DESCRIPTION OF THE DRAWINGS

The accompanying drawings are not intended to be drawn to scale. For purposes of clarity, not every component may be labeled in every drawing. In the drawings:

FIG. 1 is an electron micrograph of a filter media in accordance with one or more embodiments;

FIGS. 2a-2d depict schematic flow diagrams of a method of producing a filter media in accordance with some embodiments;

FIGS. 3a-3d depict schematic flow diagrams of another method of producing a filter media in accordance with some embodiments;

FIG. 4 is a graph showing effects of average fiber diameter on performance for filter media described in some examples;

FIGS. 5a-5c are graphs showing effects of various structural arrangements on performance for filter media described in some examples;

FIGS. 6a-6b are graphs showing effects of various agents on performance for filter media described in some examples; and

FIGS. 7a-7b are graphs showing effects of the relative amounts of various agents on performance for filter media described in some examples.

### DETAILED DESCRIPTION

Filter media and related components, systems, and methods associated therewith are described. Filter media described herein may include a substrate and one or more fine fiber layers formed on the substrate. The fine fiber layer(s) may include fine glass fibers. Due to its overall composition and, in some cases, the manner in which the filter media is produced, the filter media may exhibit desirable properties including enhanced gamma values, greater than that of conventional filter media. As noted and defined further below, a high gamma is characterized by a low resistance to fluid flow through the filter media and a high efficiency of the filter media. The filter media may also exhibit favorable mechanical properties, for example, which allow the filter media to be pleated, while also having high gamma.

In some embodiments, the substrate may be provided as a base layer (e.g., support or backing) for the filter media and the fine fiber layer(s) may be provided as the efficiency layer(s) for the filter media. For example, as a base layer, the substrate may provide mechanical support and/or pleatability for the filter media; and the efficiency layer(s) may serve to trap particles, such as fine particles (e.g., particles having a size of less than 1 micron) and/or coarse particles (e.g., particles have a size of greater than 1 micron), while, at the same time, allowing fluid (e.g., air, liquid) to pass therethrough. In some embodiments, the various layers of the filter media (e.g., substrate, fine fiber layers), while adhered together or otherwise positioned over one another, are formed in a distinct manner from one another, for example, such that certain components within each of the layers of the filter media are able to be kept separate, as suitably desired.

In accordance with aspects of the present disclosure, the fine fiber layer(s) of the filter media may include a plurality of fine glass fibers where the average fiber diameter of the fine glass fibers is less than 2 microns. Or, in some cases, at least 70% by weight of the fine glass fibers within each fine fiber layer may have a fiber diameter of less than 2 microns.

In some embodiments, a fine fiber layer of the filter media may include a fluorochemical composition, an organosilicon composition and little to no binder composition present within the fine fiber layer. That is, while the substrate may include a binder composition, for example, so that the filter media exhibits pleatability, the binder composition is only optionally present within the fine fiber layer(s) of the filter media. In some embodiments, it is preferable for there to be a minimal amount of binder within the fine fiber layer(s), if any. For example, the amount of binder composition within the fine fiber layer(s) of the filter media may be between 0% and 2% by weight of the fine fiber layer(s).

Processes described herein provide for the ability to produce filter media with certain layers having a substantial amount of binder (e.g., substrate(s)) and other layers having relatively less amount of binder (e.g., fine fiber layer(s)), which gives rise to filter media having an advantageous combination of properties. For example, a filter media may include one or more glass fiber layers where the filter media exhibits a gamma of greater than 12 and a machine direction tensile strength of greater than 3.0 lbs/inch (e.g., between 3 lbs/inch and 200 lbs/inch). Or, a filter media including one or more glass fiber layers may exhibit a gamma of greater than 12 and a stiffness of greater than 400 gu (e.g., between 400 gu and 3000 gu). In general, these values of tensile strength and stiffness may provide qualities that allow for the filter media to be pleated.

While one or more binders may have been incorporated in glass fiber layers of filter media in the past, for example, to provide structural integrity to the layer(s), such binder(s), when applied to a fine fiber layer of a filter media, in some cases, may be prone to the formation of obstructions (e.g., binder webbing, network) between glass fibers. Such obstructions may have a tendency to undesirably cover pores throughout the fiber layer (e.g., “pore blinding”). When pores of a fiber web within a filter media are covered in this manner, the pressure drop across the filter media may increase, which may, in turn, result in an overall reduction in gamma (i.e., if the overall efficiency remains unaffected).

Accordingly, despite incorporating fine glass fibers along with fluorochemical and organosilicon compositions into a fine fiber layer for producing a filter media, the presence of a binder within the fine fiber layer may, in some cases, cancel effects that the other components (e.g., fluorochemical, organosilicon) may otherwise have on gamma.

Thus, in some embodiments, fine fiber layers that are used as efficiency layers may be fabricated so as to have little to no binder present throughout the layer(s). Though, it can be appreciated that binder may be present in other parts of the filter media, such as the substrate, or base layer. For example, in some cases, the binder may serve to provide the substrate, and the overall filter media, with strength and stiffness. And, in other cases, it may be preferred to incorporate at least a small amount of binder within one or more fine fiber layers of the filter media.

In some cases, it may be beneficial for a filter media to include multiple fine fiber layers (e.g., multiple efficiency layers). Individual fine fiber layers may, at times, include small openings (e.g., pinholes) or thinned regions that allow particles to pass therethrough, resulting in a reduction in overall efficiency of the filter media. Such openings or thin spots may be particularly common in fine fiber layers where the average fiber diameter of the glass fibers within the fine fiber layer(s) is low (e.g., less than 2 microns, less than 1 micron). By layering multiple fine fiber layers over one another, small particles are more effectively obstructed from passing through the filter media, while fluid flow therethrough is, for the most part, unhindered. Accordingly, in some embodiments, multiple fine fiber layers may be superimposed over one another so as to counteract detrimental effects that may result from small openings or thin spots, which may be present within a single fine fiber layer.

In some embodiments, filter media in accordance with the present disclosure is manufactured by forming a substrate along the machine direction of a forming machine; and forming one or more layers composed, at least in part, of fine glass fibers, laid over the substrate, also along the same machine direction. In some embodiments, the fine fiber layer(s) are formed on the same forming machine as that used to form the substrate, formed in a continuous manner with the substrate, along the same machine direction. For example, the substrate layer(s) and the fine fiber layer(s) of the filter media may be formed separately from one another and laminated, or each layer may be formed along the same line of manufacture on the same machine. Each layer may be formed simultaneously, or each layer may be formed in succession during a continuous process.

Various processes for such formation are described further below, for example, using a multi-ply pressure former and/or multiple headbox arrangements. In addition, fiber mixtures to be used as precursors to corresponding substrate layers and/or fine fiber layers may be provided through a beater addition process, also described further below.

As discussed above, the filter media may include a substrate and one or more fine fiber layers adhered to or otherwise disposed on the substrate. The fine fiber layer may include any suitable number of components, such as fine glass fibers, a fluorochemical composition, a organosilicon composition, one or more additives or agents, or any other suitable component, in any appropriate combination.

In some embodiments, the fine fiber layer includes a suitable number of fine glass fibers. The fine glass fibers may have appropriate dimensions, such as within a particular range of fiber diameter and fiber length. Various dimensions of fine glass fibers may be measured by an appropriate method. Other non-glass fiber types may also be included within the fine fiber layer.

As noted above, fine glass fibers may be characterized by having a relatively small fiber diameter.

The diameter of fine glass fibers of the fine fiber layer(s) of the filter media may fall within a suitable range. In some embodiments, the fine fiber layer includes fine glass fibers having a fiber diameter of less than 5.0 microns, less than 4.0 microns, less than 3.0 microns, less than 2.0 microns, less than 1.5 microns, less than 1.0 micron, less than 0.5 microns, less than 0.3 microns, or less than 0.1 micron. For example, the fiber diameter of fine glass fibers incorporated within the fine fiber layer may be between 0.01 microns and 5.0 microns, between 0.05 microns and 3.0 microns, between 0.08 microns and 3.0 microns, between 0.08 microns and 2.0 microns, between 0.08 microns and 1.0 micron, between 0.08 microns and 0.5 microns, between 0.08 microns and 1.0 micron, between 0.1 micron and 2.0 microns, between 0.1 micron and 1.0 micron, between 0.1 micron and 0.5 microns, between 0.1 micron and 0.3 microns, between 0.15 micron and 2.0 microns, between 0.15 micron and 1.0 micron, between 0.15 micron and 0.5 microns, between 0.15 micron and 0.3 microns, between 0.3 microns and 2.0 microns, between 0.3 microns and 1.0 micron, between 0.3 microns and between 0.5 microns, between 0.5 microns and 2.0 microns, between 0.5 microns and 1.0 micron, between 1.0 micron and 2.0 microns, or any other suitable range. It should be appreciated that the above-noted ranges are not limiting and that fine glass fibers in accordance with the present disclosure may have fiber diameters that are outside of these ranges.

In various embodiments, a suitable percentage of glass fibers within the fine fiber layer(s) of the filter media may have a fiber diameter that falls within any of the above-noted ranges. For example, at least 60%, at least 70%, at least 75%, at least 80%, at least 85%, at least 90%, at least 95%, at least 97%, at least 99%, or about 100% by weight of the glass fibers within the fine fiber layer may have a fiber diameter of less than 5.0 microns, less than 4.0 microns, less than 3.0 microns, less than 2.0 microns, less than 1.5 microns, less than 1 micron, less than 0.5 microns, less than 0.3 microns, or less than 0.1 micron. Or, at least 60%, at least 70%, at least 75%, at least 80%, at least 85%, at least 90%, at least 95%, at least 97%, at least 99%, or about 100% by weight of the glass fibers within the fine fiber layer may have a fiber diameter of between 0.01 microns and 5.0 microns, between 0.05 microns and 3.0 microns, between 0.08 microns and 3.0 microns, between 0.08 microns and 2.0 microns, between 0.08 microns and 1.0 micron, between 0.08 microns and 0.5 microns, between 0.08 microns and 1.0 micron, between 0.1 micron and 2.0 microns, between 0.1 micron and 1.0 micron, between 0.1 micron and 0.5 microns, between 0.1 micron and 0.3 microns, between 0.15 micron and 2.0 microns, between 0.15 micron and 1.0 micron, between 0.15 micron and 0.5 microns, between 0.15 micron and 0.3 microns, between 0.3 microns and 2.0 microns, between 0.3 microns and 1.0 micron, between 0.3 microns and 0.5 microns, between 0.5 microns and 2.0 microns, between 0.5 microns and 1.0 micron, between 1.0 micron and 2.0 microns, or any other suitable range.

In some embodiments, the average diameter of fine glass fibers of the fine fiber layer(s) of the filter media may fall within any of the above-noted ranges. For example, the average fiber diameter of fine glass fibers of the fine fiber layer(s) of the filter media may be less than 5.0 microns, less than 4.0 microns, less than 3.0 microns, less than 2.0 microns, less than 1.0 micron, less than 0.5 microns, less than 0.3 microns, or less than 0.1 micron. Or, the average fiber diameter of fine glass fibers of the fine fiber layer(s) may be between 0.01 microns and 5.0 microns, between 0.05 microns and 3.0 microns, between 0.08 microns and 3.0 microns, between 0.08 microns and 2.0 microns, between 0.08 microns and 1.0 micron, between 0.08 microns and 0.5 microns, between 0.08 microns and 1.0 micron, between 0.1 micron and 2.0 microns, between 0.1 micron and 1.0 micron, between 0.1 micron and 0.5 microns, between 0.1 micron and 0.3 microns, between 0.15 micron and 2.0 microns, between 0.15 micron and 1.0 micron, between 0.15 micron and 0.5 microns, between 0.15 micron and 0.3 microns, between 0.3 microns and 2.0 microns, between 0.3 microns and 1.0 micron, between 0.3 microns and 0.5 microns, between 0.5 microns and 2.0 microns, between 0.5 microns and 1.0 micron, between 1.0 micron and 2.0 microns, or any other suitable range. In some cases, average diameter distributions for fine glass fibers may be log-normal. However, it can be appreciated that fine glass fibers may be provided in any other appropriate average diameter distribution (e.g., Gaussian distribution).

Fine glass fibers in accordance with the present disclosure may have any suitable length. In some embodiments, the fine fiber layer(s) of the filter media include fine glass fibers having an average fiber length of between 0.01 mm and 60.0 mm, between 0.02 mm and 60.0 mm, between 0.03 mm and 60.0 mm, between 0.05 mm and 60.0 mm, between 1.0 mm and 60.0 mm, between 2.0 mm and 60.0 mm, between 3.0 mm and 60.0 mm, between 4.0 mm and 60.0 mm, between 5.0 mm and 60.0 mm, between 0.01 mm and 50.0 mm, between 0.01 mm and 40.0 mm, between 0.01 mm and 30.0 mm, between 0.01 mm and 25.4 mm, between 0.01 mm and 25.0 mm, between 0.01 mm and 20.0 mm, between 0.01 mm and 10.0 mm, between 0.02 mm and 50.0 mm, between 0.02 mm and 40.0 mm, between 0.02 mm and 30.0 mm, between 0.02 mm and 25.4 mm, between 0.02 mm and 25.0 mm, between 0.02 mm and 20.0 mm, between 0.02 mm and 10.0 mm, between 0.03 mm and 50.0 mm, between 0.03 mm and 40.0 mm, between 0.03 mm and 30.0 mm, between 0.03 mm and 25.4 mm, between 0.03 mm and 25.0 mm, between 0.03 mm and 20.0 mm, between 0.03 mm and 10.0 mm, between 0.05 mm and 50.0 mm, between 0.05 mm and 40.0 mm, between 0.05 mm and 30.0 mm, between 0.05 mm and 25.4 mm, between 0.05 mm and 25.0 mm, between 0.05 mm and 20.0 mm, between 0.05 mm and 10.0 mm, between 1.0 mm and 50.0 mm, between 1.0 mm and 40.0 mm, between 1.0 mm and 30.0 mm, between 1.0 mm and 25.4 mm, between 1.0 mm and 25.0 mm, between 1.0 mm and 20.0 mm, between 1.0 mm and 10.0 mm, or any other suitable range. Similar to that with respect to average diameter distributions, average length distributions for fine glass fibers may be log-normal. Though, fine glass fibers described herein may be provided according to any other suitable average length distribution (e.g., Gaussian distribution). It is noted that fine glass fibers described herein may have fiber lengths that fall outside of the above-noted ranges.

In accordance with the present disclosure, the percentage of fine glass fibers within an overall filter media composite, for example, a filter media including the substrate(s) (e.g., scrim), fine fiber layers, other layers and/or other filtration component(s), may fall within a suitable range. In some embodiments, fine glass fibers may comprise at least 0.5%, at least 1.0%, at least 1.5%, at least 2.0%, at least 2.5%, at least 3.0%, at least 3.5%, at least 4.0%, at least 4.5%, at least 5.0%, at least 10%, at least 20%, at least 30%, at least 40%, at least 50%, at least 60%, at least 70%, or about 80%, or any other suitable range, by weight of the overall filter media. Or, in some embodiments, fine glass fibers may comprise between 0.5% and 80%, between 1.0% and 80%, between 1.5% and 80%, between 2.0% and 80%, between 2.5% and 80%, between 3.0% and 80%, between 0.5% and 70%, between 1.0% and 70%, between 1.5% and 70%, between 2.0% and 70%, between 2.5% and 70%, between 3.0% and 70%, between 0.5% and 70%, between 1.0% and 70%, between 1.5% and 70%, between 2.0% and 70%, between 2.5% and 70%, between 3.0% and 70%, between 0.5% and 60%, between 1.0% and 60%, between 1.5% and 60%, between 2.0% and 60%, between 2.5% and 60%, between 3.0% and 60%, between 1.0% and 60%, between 1.0% and 50%, between 1.0% and 40%, between 1.0% and 30%, between 1.0% and 20%, between 1.0% and 10.0%, between 5.0% and 50%, between 5.0% and 40%, between 5.0% and 30%, between 5.0% and 20%, between 10% and 50%, between 10% and 40%, between 10% and 30%, between 10% and 20%, or any other suitable range, by weight of the overall filter media.

In accordance with further aspects of the present disclosure, any appropriate fine glass fiber may be employed, such as microglass fibers, or other types of glass fiber.

In some embodiments, certain layers of the filter media (e.g., fine fiber layers, substrate layers) incorporate a suitable percentage of a fluorochemical composition, e.g., an organic or inorganic composition that includes at least one fluorine atom, and/or an organosilicon composition, e.g., a compound that contains silicon-carbon bonds. The addition of both a fluorochemical composition and an organosilicon composition, or only one of the compositions, to layers of a filter media may serve to enhance overall performance of the filter media, for example, gamma of the filter media may be increased.

Several factors may contribute to the filter media exhibiting an enhanced gamma upon incorporation of the fluorochemical and/or organosilicon composition(s). Without wishing to be bound by theory, a number of these factors are discussed below.

Due to the presence of fluorine, fluorochemical compositions generally have functional groups that are strongly electronegative. Thus, it is thought that particles passing through the filter media may be electrostatically attracted to the fluorochemical, trapping the particles so as to result in an increase in efficiency.

Organosilicon compositions, on the other hand, may have properties that lead to a decrease in overall solidity of one or more layers of the filter media, making the layer(s) more consistent. This may have the effect of reducing the amount of pinholes that may otherwise arise in the layer(s), also leading to an increase in efficiency of the filter media.

In some embodiments, the organosilicon composition may be effective to reduce the surface tension of the binder composition, allowing the binder to flow more readily around the fibers of the layer. When the binder composition is able to cover the fibers more evenly, due to an increased ability to flow, binder webbing is less prone to formation, resulting in a reduced pressure drop of the filter media, hence, increasing gamma.

In some embodiments, the combination of fluorochemical and organosilicon compositions incorporated within a fine fiber layer, or other layer, of the filter media may lead to a synergistic effect where the overall filter media exhibits a higher gamma than expected. In some cases, this enhanced gamma of the filter media is not a gamma that has been observed in filter media absent one of the fluorochemical and organosilicon compositions, or one of the fluorochemical and organosilicon compositions by itself, within one or more layers of the filter media.

One theory as to why the combined chemistry of fluorochemical and organosilicon compositions together results in a particularly advantageous gamma is that there is a tendency for the organosilicon to interact with the fluorochemical such that the fluorochemical migrates to the surface of the fibers. As discussed above, particles passing through the filter media may be immobilized by the presence of fluorochemical. Thus, when the presence of organosilicon promotes the fluorochemical to be located more prominently on the surface of the fibers, the efficiency of the filter media may increase, resulting in an increase in gamma.

Accordingly, incorporating both a fluorochemical composition and an organosilicon composition together, according to a suitable ratio, into the fine fiber layer(s) may result in a filter media having a greater performance enhancement than if the fine fiber layer(s) of the filter media incorporates only one of the components, without the other. That is, the combination of the fluorochemical composition and the organosilicon composition together within a fiber layer (e.g., fine fiber layer) may result in better overall performance (e.g., greater gamma) than use of either of the agents alone.

However, it should be appreciated that, in some cases, a filter media (or fine fiber layer or substrate layer of the filter media) that incorporates only a particular fluorochemical composition, without an organosilicon composition, or a particular organosilicon composition, without a fluorochemical composition, may result in a filter media that exhibits comparatively better performance characteristics than a filter media that incorporates both a fluorochemical composition and an organosilicon composition. For some applications, while not every application, it may be preferred that fluorochemical compositions and/or organosilicon compositions be absent from certain layers (e.g., fine fiber layers, substrate layers, other layers) within the filter media.

As noted above, a fine fiber layer, or other layer, of the filter media described herein may include a suitable fluorochemical composition. In some embodiments, the fluorochemical composition includes an organofluorine, such as, but not limited to, fluoroaliphatics, fluoroaromatics, fluoropolymers (e.g., fluorocarbon block co-polymers, fluorocarbon acrylates, fluorocarbon methacrylates). Fluorochemical compositions used in accordance with the present disclosure may also include fluoroelastomers, fluorosilicones, fluorosilanes, fluorosiloxanes, fluoro polyhedral oligomeric silsesquioxanes (Fluoro-POSS), fluorinated dendrimers, or other fluorinated composition. Various examples of fluorochemical compositions that may be incorporated in a fine fiber layer, or other layer, of the filter media in accordance with the present disclosure include Daikin TG5243, Ruco 1046, Repearl F35, AGE400, AGE600, AGE550D, Phobol 8195, amongst others. It can be appreciated that any other suitable fluorochemical composition, and/or combinations thereof, may be used appropriately in various embodiments presented herein.

The fluorochemical composition may comprise a suitable weight percentage of a fine fiber layer, or other layer (e.g., substrate layer, intermediate layer), of the filter media. In some embodiments, the fluorochemical composition comprises less than 10%, less than 8%, less than 6%, less than 4%, less than 2%, less than 1%, less than 0.1%, less than 0.01%, less than 0.005%, or less than 0.001% by weight of the filter media, the fine fiber layer, or other layer. In some embodiments, the fluorochemical composition may range between 0.001% and 10%, between 0.001% and 8.0%, between 0.001% and 6.0%, between 0.001% and 4.0%, between 0.001% and 2.0%, between 0.001% and 1.0%, between 0.001% and 0.1%, between 0.001% and 0.01%, between 0.001% and 0.005%, between 0.01% and 10%, between 0.01% and 8.0%, between 0.01% and 6.0%, between 0.01% and 4.0%, between 0.01% and 2.0%, between 0.01% and 1.0%, between 0.1% and 10.0%, between 0.1% and 8.0%, between 0.1% and 6.0%, between 0.1% and 4.0%, between 0.1% and 2.0%, between 0.1% and 1.0%, between 0.5% and 10.0%, between 0.5% and 8.0%, between 0.5% and 6.0%, between 0.5% and 4.0%, between 0.5% and 2.0%, between 0.5% and 1.0%, between 1.0% and 10.0%, between 1.0% and 8.0%, between 1.0% and 6.0%, between 1.0% and 4.0%, or between 1.0% and 2.0% by weight of the filter media, fine fiber layer, or other appropriate layer of the filter media.

As noted above, the fine fiber layer, or other suitable layer, of the filter media may include a suitable organosilicon composition. In some embodiments, organosilicon compositions that may be incorporated in embodiments of the present disclosure may include polysilanes (where silicon atoms are directly attached to one another), polysiloxanes (where silicon atoms are attached through an oxygen atom), polysilazanes (where silicon atoms are attached through an amine linkage), polysilthianes (where silicon atoms are attached through a sulfur atom), polysilalkylenes, polysilarylenes, polysilalkylenesiloxanes, polysilarylenosiloxanes, polysilalkylenosilanes, amino silicones, epoxy silicones, polydimethylsiloxanes, or other suitable silicon containing molecules. For example, polysiloxane, such as product SF30 obtained from Momentive, may be suitably employed. Or, various examples of organosilicon compositions that may be incorporated in a fine fiber layer, or other layer, of the filter media in accordance with the present disclosure include Strucksilon F-84 obtained from Schill and Seilacher, Serashine EM 302C obtained from Basildon, amongst others.

In some cases, an organosilicon composition incorporated into embodiments of the present disclosure may be linear, cyclic, branched, monomeric, oligomeric, or polymeric in nature. In some embodiments, suitable organosilicon compositions may include one or more terminal or branched side functional groups, such as chlorine, hydroxide group(s), methyl group(s), amine group(s), etc. It can be appreciated that any other suitable organosilicon composition, and/or combinations thereof, may be appropriately used in embodiments presented herein.

Similar to that with respect to the fluorochemical composition, the organosilicon composition may comprise a suitable weight percentage of a fine fiber layer, or other layer (e.g., substrate layer, intermediate layer), of the filter media, in accordance with the present disclosure. In some embodiments, the organosilicon composition comprises less than 10%, less than 8%, less than 6%, less than 4%, less than 2%, or less than 1% by weight of the filter media, fine fiber layer, or other layer, of the filter media. In some embodiments, the organosilicon composition may range between 0.001% and 10%, between 0.001% and 8.0%, between 0.001% and 6.0%, between 0.001% and 4.0%, between 0.001% and 2.0%, between 0.001% and 1.0%, between 0.001% and 0.1%, between 0.001% and 0.01%, between 0.001% and 0.005%, between 0.01% and 10%, between 0.01% and 8.0%, between 0.01% and 6.0%, between 0.01% and 4.0%, between 0.01% and 2.0%, between 0.01% and 1.0%, between 0.1% and 10.0%, between 0.1% and 8.0%, between 0.1% and 6.0%, between 0.1% and 4.0%, between 0.1% and 2.0%, between 0.1% and 1.0%, between 0.5% and 10.0%, between 0.5% and 8.0%, between 0.5% and 6.0%, between 0.5% and 4.0%, between 0.5% and 2.0%, between 0.5% and 1.0%, between 1.0% and 10.0%, between 1.0% and 8.0%, between 1.0% and 6.0%, between 1.0% and 4.0%, or between 1.0% and 2.0% by weight of the filter media, fine fiber layer, or other suitable layer of the filter media.

The combined amount of fluorocarbon and organo silicon composition may comprise a suitable weight percentage of the filter media, a fine fiber layer, or other layer of the filter media. For example, suitable weight percentages listed above with respect to the fluorocarbon composition or the organosilicon composition may apply to the combination of fluorocarbon and organosilicon composition together within the filter media, a fine fiber layer, or other layer of the filter media.

As noted above, some fine fiber layers, or other layers, of the filter media in accordance with the present disclosure may include a fluorochemical composition, in the absence of an organosilicon composition; conversely, some fine fiber layers, or other layers, of the filter media may include an organosilicon composition, in the absence of a fluorochemical composition.

Alternatively, fine fiber layers, or other layers, may include both fluorochemical and organosilicon compositions, in which case the fluorochemical and organosilicon compositions may be provided in accordance with a suitable ratio. In some embodiments, the ratio between fluorochemical and organosilicon compositions (fluorochemical:organosilicon, FC:Si) within a fine fiber layer is between 1:199 and 199:1, between 1:149 and 149:1, between 1:99 and 99:1, between 1:49 and 49:1, between 1:9 and 9:1, between 1:8 and 8:1, between 1:7 and 7:1, between 1:6 and 6:1, between 1:5 and 5:1, between 1:4 and 4:1, between 1:3 and 3:1, between 1:2 and 2:1, or 1:1, between 199:1 and 1:1, between 149:1 and 1:1, between 99:1 and 1:1, between 49:1 and 1:1, between 19:1 and 1:1, between 9:1 and 1:1, between 9:1 and 5:1, between 5:1 and 1:1, between 5:1 and 2:1, between 5:1 and 3:1, between 4:1 and 3:1, between 4:1 and 2:1, between 1:199 and 1:1, between 1:149 and 1:1, between 1:99 and 1:1, between 1:49 and 1:1, between 1:19 and 1:1, between 1:9 and 1:1, between 1:9 and 1:5, between 1:5 and 1:1, 1:5 and 1:2, 1:5 and 1:3, 1:4 and 1:3, 1:4 and 1:2. The ratio between fluorochemical and organosilicon compositions within a fine fiber layer may vary outside of these ranges.

In some embodiments, where both fluorochemical and organosilicon compositions are incorporated within a fine fiber layer, or other layer of the filter media, it may be preferable for the fluorochemical composition to be comparatively greater in amount than the organosilicon composition. For instance, a ratio of fluorochemical to organosilicon within a fine fiber layer of between 5:1 and 2:1 (e.g., between 4:1 and 2:1, or 3:1) may give rise to a particularly high gamma value for some embodiments of the filter media.

One or more layers of the filter media (e.g., fine fiber layer, substrate layer, intermediate layer) may include additional components, which may comprise a relatively small weight percentage of the filter media, or layers within the filter media, e.g., as compared to the weight percentage of fibers.

In some embodiments, through a beater addition process, which is described in more detail further below with respect to the fine fiber layer and the substrate layer, various agents, such as flocculents or coagulants, may be used to adhere or otherwise deposit certain components to the fibers so as to assist formation of layers of the filter media.

In some embodiments, a binder composition may be provided to one or more layers of the filter media. The binder composition may be incorporated into a substrate layer, and may be optionally provided to the fine fiber layer. As discussed above, in some cases but not necessarily all situations, when the fine fiber layer is used as an efficiency layer, the binder composition may have a tendency to form a web between glass fibers, blocking pores of the layer which may lead to an increased pressure drop across the filter media during use. Accordingly, in some embodiments, while not required in all instances, it may be preferable for the fine fiber layer to be substantially free of binder composition. However, in some embodiments, incorporation of the binder composition in one or more layers (e.g., substrate layers) of the filter media may be provided for an added, or otherwise enhanced, mechanical strength and pleatability to the filter media.

In general, a binder composition may include any suitable material. The binder composition may comprise a thermoplastic, a thermoset, or a combination thereof. For example, the binder composition may include acrylic, acrylic resin (e.g., acrylic thermoset resin), epoxy, vinyl acrylic, latex emulsion, nitrile, styrene, styrene-acrylic, styrene butadiene rubber, polyvinyl chloride, ethylene vinyl chloride, polyolefin, polyvinyl halide, polyvinyl ester, polyvinyl ether, polyvinyl sulfate, polyvinyl phosphate, polyvinyl amine, polyamide, polyimide, polyoxidiazole, polytriazol, polycarbodiimide, polysulfone, polycarbonate, polyether, polyarylene oxide, polyester, polyarylate, phenolics, phenol-formaldehyde resin, melamine-formaldehyde resin, formaldehyde-urea, vinyl acetate, ethylene vinyl acetate, ethyl-vinyl acetate copolymer, or other suitable compositions. The binder composition may be anionic, cationic, or non-ionic in nature. The binder composition may be provided as an aqueous or solvent-based system.

As discussed, the binder composition may be optionally present within one or more layers (e.g., fine fiber layer, substrate layer) of the filter media. In some embodiments, the binder composition may comprise less than 40%, less than 30%, less than 20%, less than 10%, less than 5.0%, less than 4.0%, less than 3.0%, less than 2.0%, less than 1.0%, less than 0.5%, or less than 0.1% by weight of the filter media, fine fiber layer, or other appropriate layer, of the filter media. For example, the binder composition may comprise between 0% and 40%, 0% and 30%, 0% and 20%, 0% and 10%, between 0% and 5.0%, between 0% and 4.0%, between 0% and 3.0%, between 0% and 2.0%, between 0% and 1.0%, between 0% and 0.5%, or between 0% and 0.1%, by weight of the filter media, fine fiber layer, or other appropriate layer, of the filter media. In some embodiments, the filter media, fine fiber layer, or other layer of the filter media is substantially free of binder composition.

It can be appreciated that the fine fiber layer, or other layer of the filter media, may include binder composition outside of the above noted ranges. For example, the percentage of binder composition provided within the substrate may be greater than the percentage of binder composition incorporated within the fine fiber layer(s). The above noted ranges may also apply to the overall filter media as a whole. As such, the filter media may also include binder composition outside of these ranges.

One or more layers of the filter media may include other compositions, as appropriate. In some embodiments, various layers of the filter media (e.g., fine fiber layer(s), substrate layer(s), etc.) may include one or more additives or agents (typically in small amounts/percentages), such as anti-bacterial agents, fungicides, flame retardants, dyes, dispersants, surfactants, defoamers, coupling agents, crosslinking agents, thickeners, catalysts, ammonia, fillers, optical brighteners, absorbents, anti-static agents, amongst others. It should be understood that filter media described herein are not limited to the above-noted components and weight percentages, as other components and weight percentages are possible.

As discussed, the filter media may include one or more fine fiber layers positioned on, or with, one or more substrate layers. In some embodiments, the substrate layer(s) provide support and/or pleatability for the filter media. Thus, the substrate layer(s) may exhibit a number of characteristics, such as a high degree of pleatability, stiffness, strength, amongst others.

The substrate layer(s) may be wet laid or dry laid, woven or nonwoven, and formed of any suitable combination of materials. For instance, the substrate layer(s) may include glass fibers (coarse and/or fine glass fibers) and/or synthetic fibers. In some embodiments, the fibers of the substrate layer(s) may include an appropriate combination of materials, such as glass, cellulose (e.g., lyocell, rayon, regenerated cellulose, hardwood, softwood, etc.), polyester, polyamide, polyolefin, polyimide, polyethylene, polypropylene, polyethylene terephthalate, polyolefin, aramid, ceramic, carbon, acrylic, amongst others. The substrate layer(s) may further include bi-component fibers, multi-component fibers, binder fibers, or other synthetic fibers.

In some embodiments, a substrate layer may be a scrim and/or other appropriate backing for the fine fiber layer(s) of the filter media. In some embodiments, a substrate layer includes a dry laid nonwoven fabric that exhibits a high level of air permeability. In some embodiments, a substrate layer includes an adhesive (e.g., low melting point adhesive) located on one side of the filter media to facilitate bonding of the substrate layer to other layers of the filter media, or bonding of the substrate layer to a precursor of another layer of the filter media.

The substrate layer(s) may include additional non-fibrous components, such as binder compositions and/or additives. For instance, the substrate layer(s) may include a binder composition, water repellent, silicone, anti-bacterial agents, fungicides, flame retardants, dyes, dispersants, surfactants, defoamers, external cross-linkers, thickeners, catalysts, pH controller, fillers, optical brighteners, absorbents, anti-static agents, retention aids, anti-migration additives, amongst others. The substrate layer(s) may include additional components not listed herein.

The substrate layer(s) may exhibit any appropriate set of structural characteristics. For instance, the substrate layer(s) may have a suitable structure, weight, thickness, basis weight, etc. In some embodiments, the substrate layer(s) may be attached to a fine fiber layer. Examples of a suitable substrate may include, for example, a wet laid in-line backer, a meltblown layer, a dry-laid backer, a calendered or hot pressed backer, a spun-bond layer, a hydroentangled layer, a thermal bonded layer, a filtration membrane, a scrim, or any other suitable structure. It can be appreciated that a substrate may be pleatable and/or serve as a protective layer, or could be another type of structure upon which other layers of the filter media are placed.

In accordance with aspects of the present disclosure, the filter media may be formed so as to have any suitable layered arrangement. As discussed above, the filter media may have one or more fine fiber layers adhered to or otherwise positioned on one or more substrate layers.

In some cases, as noted above, one or more of the fine fiber layers may have pinholes and/or thinned regions located at various locations (e.g., randomly) throughout the fine fiber layer. However, in some embodiments, the filter media may be reinforced, from a filtration standpoint, by layering multiple fine fiber layers over one another on the substrate layer(s). This layering together of multiple fine fiber layers (e.g., two, three, four, five, six, or more fine fiber layers) may serve to effectively cover the pinholes, which may be present at particular locations within a single fine fiber layer. As a result, the overall efficiency of the filter media may increase, resulting in an increase in gamma.

In some embodiments, the filter media may be formed so that multiple fine fiber layers are disposed between oppositely positioned substrate layers located at respective upstream and downstream ends. Substrate layers located on opposite upstream and downstream ends of the filter media may afford protection for the fine fiber layers disposed therebetween, preserving the efficiency of the filter media and limiting shedding of fine glass from the fine fiber layer(s).

Substrate layers may, in general, have a more open configuration than the fine fiber layers. Thus, by having the substrate layers positioned on opposite ends of the filter media, more dust is able to be trapped within the substrate layers, resulting in an increase in the overall dust holding capacity of the filter media.

In some embodiments, substrate layers are greater in stiffness and strength as compared with the fine fiber layers. Accordingly, the substrate layers may provide an added degree of protection for the filter media. The substrate layers may also provide the filter media with a greater degree of pleatability as compared with filter media absent the substrate layers.

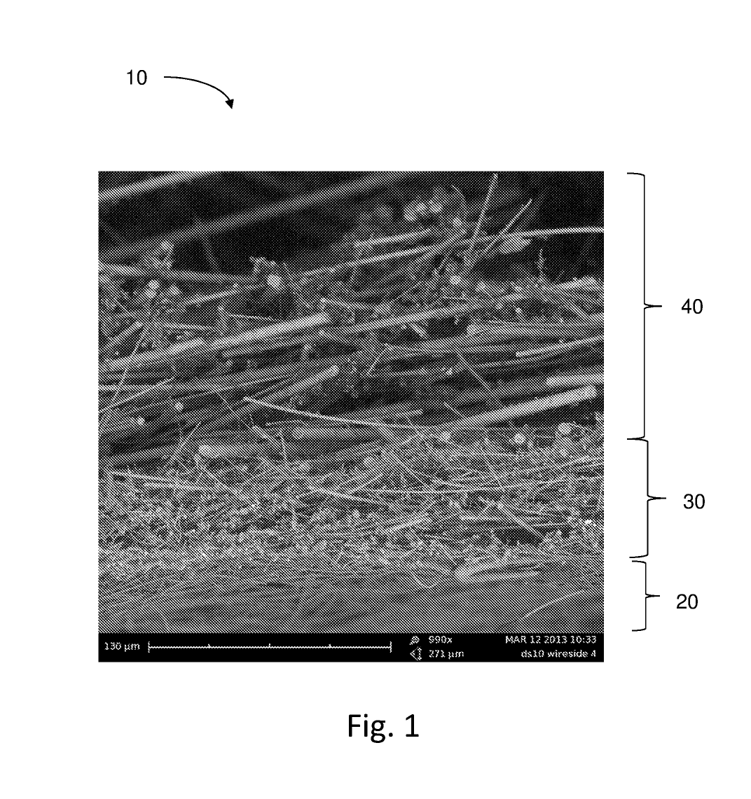

In some embodiments, one or more intermediate layers may be positioned between a fine fiber layer and a substrate layer. The intermediate layer, for example, may have characteristics that are distinct from the substrate layer or the fine fiber layer. FIG. 1 depicts a cross-sectional view of an example of a filter media 10 that includes a fine fiber layer 20, an intermediate layer 30 and a substrate layer 40. In this embodiment, the substrate layer 40 is an open layer, acting as a coarse pre-filter that traps large agglomerates of dust. The intermediate layer 30 may serve as a less coarse pre-filter by trapping large, single particles. Both layers 30, 40 provide for relatively high levels of depth filtration, leading to a higher dust holding capacity of the filter media. The fine fiber layer 20, which is comparatively tighter in nature, may be used as an efficiency layer.

It should be appreciated that the filter media may include other parts in addition to fiber webs (e.g., fine fiber layers, substrate layers comprising fibers, etc.). In some embodiments, one or more structural features and/or stiffening elements may be incorporated in the filter media. Further, the nonwoven glass fiber web(s) of the filter media may be combined with additional structural components, such as woven supporting material, polymeric and/or metallic meshes. Such additional structural components may impart enhanced mechanical characteristics (e.g., stiffness, tensile strength, etc.) to the overall filter media. For example, a screen backing may be disposed on the filter media, providing for further stiffness and strength. In some cases, a screen backing may aid in retaining a pleated configuration of the filter media. For example, a screen backing may be an expanded metal wire or an extruded plastic mesh.

The filter media may have a variety of desirable properties and characteristics which, in some cases, may vary depending on the particular application for which the filter media is used. For example, the filter media described herein may have varying basis weights, solidities, thicknesses and/or other characteristics, depending upon the requirements of a desired application.

Certain characteristics, such as basis weight, solidity, thickness or other features of the filter media, or the individual layer(s) (e.g., fine fiber layers), may vary depending on certain factors, such as the requirements (e.g., structural, performance requirements) of a given filtering application (e.g., HEPA, ASHRAE, ULPA, etc.), and the materials used to form the filter media. For example, filter media including coarser fibers and/or layers with lower basis weight may, in general, be more suitable for ASHRAE applications; in contrast, filter media that include finer fibers and/or layers with greater basis weight may generally be more suitable for HEPA applications.

The filter media and the layers within the filter media may have any suitable basis weight. However, the basis weight of the filter media or the layers within the filter media may vary depending on the application. As determined herein, the basis weight of the filter media or individual layers of the filter media are measured according to TAPPI 410.

As discussed above, the basis weight of the filter media may vary depending on the application for which the filter media is used. In some embodiments, the basis weight of the filter media (e.g., including the fine fiber layer(s) and substrate(s)) may range from between 1.0 gsm (grams per square meter) and 1000 gsm, between 1.0 gsm and 900 gsm, between 1.0 gsm and 800 gsm, between 1.0 gsm and 600 gsm, between 1.0 gsm and 400 gsm, between 1.0 gsm and 200 gsm, between 1.0 gsm and 100 gsm, between 2.0 gsm and 800 gsm, between 2.0 gsm and 600 gsm, between 2.0 gsm and 400 gsm, between 2.0 gsm and 200 gsm, between 2.0 gsm and 100 gsm, between 5.0 gsm and 1000 gsm, between 5.0 gsm and 800 gsm, between 5.0 gsm and 600 gsm, between 5.0 gsm and 400 gsm, between 5.0 gsm and 200 gsm, between 5.0 gsm and 100 gsm, between 10 gsm and 1000 gsm, between 10 gsm and 800 gsm, between 10 gsm and 600 gsm, between 10 gsm and 400 gsm, between 10 gsm and 200 gsm, between 10 gsm and 100 gsm, between 50 gsm and 1000 gsm, between 50 gsm and 800 gsm, between 50 gsm and 600 gsm, between 50 gsm and 400 gsm, between 50 gsm and 200 gsm, between 50 gsm and 100 gsm, between 100 gsm and 1000 gsm, between 100 gsm and 800 gsm, between 100 gsm and 600 gsm, between 100 gsm and 400 gsm, or between 100 gsm and 200 gsm. Filter media described herein may exhibit basis weights outside of the above noted ranges.

The fine fiber layer(s) of the filter media may also have any suitable basis weight. In general, as discussed above, fine fiber layers that have too low a basis weight, are too thin and/or exhibit low solidity may have numerous pinholes and/or thin spots present within the fine fiber layer, which may affect overall performance, resulting in a reduced efficiency and gamma of the filter media. On the other hand, when the fiber packing density of the fibers within a fine fiber layer is too high, corresponding to an increase in basis weight, thickness and/or solidity, the fluid flow through the filter media may be further obstructed, resulting in an increase in pressure drop, hence, a reduction in gamma.

In some embodiments, the basis weight of the fine fiber layer(s), individually or combined together, may range between 0.1 gsm and 300 gsm, between 0.1 gsm and 200 gsm, between 0.1 gsm and 150 gsm, between 0.1 gsm and 100 gsm, between 0.5 gsm and 300 gsm, between 0.5 gsm and 200 gsm, between 0.5 gsm and 150 gsm, between 0.5 gsm and 100 gsm, between 0.5 gsm and 50 gsm, between 1.0 gsm and 300 gsm, between 1.0 gsm and 200 gsm, between 1.0 gsm and 150 gsm, between 1.0 gsm and 100 gsm, between 1.0 gsm and 50 gsm, between 1.0 gsm and 40 gsm, between 1.0 gsm and 30 gsm, between 1.0 gsm and 20 gsm, between 5.0 gsm and 50 gsm, between 5.0 gsm and 40 gsm, between 5.0 gsm and 30 gsm, between 5.0 gsm and 20 gsm, between 10.0 gsm and 300 gsm, between 10.0 gsm and 200 gsm, between 10.0 gsm and 150 gsm, between 10.0 gsm and 100 gsm, between 10.0 gsm and 50 gsm, between 50 gsm and 300 gsm, between 50 gsm and 200 gsm, between 50 gsm and 150 gsm, or between 50 gsm and 100 gsm. Fine fiber layers of filter media described herein may exhibit basis weights outside of the above noted ranges.

The filter media and the fine fiber layer(s) of the filter media may exhibit an appropriate level of solidity. Similar to that with respect to basis weight, the solidity of the filter media and/or the fine fiber layer(s) may have an effect on overall performance characteristics of the filter media. For example, a low solidity may result in a reduction in efficiency, yet too high a solidity may result in an increase in pressure drop across the filter media.

The filter media may exhibit any appropriate level of solidity. As with basis weight, the solidity of the filter media may vary depending on the application for which the filter media is used. In some embodiments, the solidity of the filter media (e.g., including the fine fiber layer(s) and substrate(s)) may range from between 0.001% and 75%, between 0.001% and 60%, between 0.001% and 50%, between 0.001% and 40%, between 0.001% and 30%, between 0.001% and 20%, between 0.001% and 10%, between 0.001% and 1.0%, between 0.001% and 0.1%, between 0.001% and 0.01%, 0.01% and 75%, between 0.01% and 60%, between 0.01% and 50%, between 0.01% and 40%, between 0.01% and 30%, between 0.01% and 20%, between 0.01% and 10%, between 0.01% and 1.0%, between 0.1% and 75%, between 0.1% and 60%, between 0.1% and 50%, between 0.1% and 40%, between 0.1% and 30%, between 0.1% and 20%, between 0.1% and 10%, between 0.1% and 1.0%, 1.0% and 75%, between 1.0% and 60%, between 1.0% and 50%, between 1.0% and 40%, between 1.0% and 30%, between 1.0% and 20%, between 1.0% and 10%, between 10.0% and 75%, between 10.0% and 60%, between 10.0% and 50%, between 10.0% and 40%, between 10.0% and 30%, or between 10.0% and 20%. Filter media described herein may exhibit solidity levels outside of the above noted ranges.

The fine fiber layer(s) of the filter media may exhibit an appropriate level of solidity, which may vary depending on the type of filtration application. For various embodiments, the solidity of the fine fiber layer(s) may fall within the ranges described above with respect to the filter media. Fine fiber layers described herein may also exhibit solidity levels outside of the above noted ranges.

The filter media and the fine fiber layer within the filter media may have any suitable thickness which, as referred to herein, is determined according to TAPPI 411. In some embodiments, for filter media or fine fiber layers within the filter media that are too low in thickness, efficiency may decrease (e.g., due to a decreased ability to trap small particles), reducing gamma; yet if the thickness of the filter media or the fine fiber layer is too high, the pressure drop may increase (e.g., by not permitting fluid to flow freely through the filter media), also reducing gamma.

The filter media may have any suitable thickness. The thickness of the filter media may be between 30 microns and 60 mm, between 30 microns and 50.8 mm, between 30 microns and 50 mm, between 30 microns and 40 mm, between 30 microns and 30 mm, between 30 microns and 25.4 mm, between 30 microns and 20 mm, between 30 microns and 10 mm, between 30 microns and 1.0 mm, between 30 microns and 500 microns, between 30 microns and 200 microns, between 40 microns and 60 mm, between 40 microns and 50.8 mm, between 40 microns and 50 mm, between 40 microns and 40 mm, between 40 microns and 30 mm, between 40 microns and 25.4 mm, between 40 microns and 20 mm, between 40 microns and 10 mm, between 40 microns and 1.0 mm, between 40 microns and 500 microns, between 40 microns and 200 microns, between 40 microns and 100 microns, between 40 microns and 50 microns, between 100 microns and 60 mm, between 100 microns and 50.8 mm, between 100 microns and 50 mm, between 100 microns and 40 mm, between 100 microns and 30 mm, between 100 microns and 25.4 mm, between 100 microns and 20 mm, between 100 microns and 10 mm, between 100 microns and 1.0 mm, between 100 microns and 500 microns, between 100 microns and 200 microns, between 30 microns and 100 microns, between 30 microns and 50 microns, between 1 mm and 60 mm, between 10 mm and 60 mm, between 20 mm and 60 mm, between 30 mm and 60 mm, between 40 mm and 60 mm, or between 50 mm and 60 mm. Filter media described herein may have thicknesses outside of the above noted ranges.

The fine fiber layer(s), individually or combined together, of the filter media may also have any suitable thickness. The thickness of a fine fiber layer(s) within the filter media may be between 10 microns and 60 mm, between 10 microns and 50.8 mm, between 10 microns and 50 mm, between 10 microns and 40 mm, between 10 microns and 30 mm, between 10 microns and 25.4 mm, between 10 microns and 20 mm, between 10 microns and 10 mm, between 10 microns and 1.0 mm, between 10 microns and 500 microns, between 10 microns and 200 microns, between 10 microns and 100 microns, between 10 microns and 50 microns, between 20 microns and 60 mm, between 20 microns and 50.8 mm, between 20 microns and 50 mm, between 20 microns and 40 mm, between 20 microns and 30 mm, between 20 microns and 25.4 mm, between 20 microns and 20 mm, between 20 microns and 10 mm, between 20 microns and 1.0 mm, between 20 microns and 500 microns, between 20 microns and 200 microns, between 20 microns and 100 microns, between 20 microns and 50 microns, between 40 microns and 60 mm, between 40 microns and 50.8 mm, between 40 microns and 50 mm, between 40 microns and 40 mm, between 40 microns and 30 mm, between 40 microns and 25.4 mm, between 40 microns and 20 mm, between 40 microns and 10 mm, between 40 microns and 1.0 mm, between 40 microns and 500 microns, between 40 microns and 200 microns, between 40 microns and 100 microns, between 40 microns and 50 microns, between 100 microns and 60 mm, between 100 microns and 50.8 mm, between 100 microns and 50 mm, between 100 microns and 40 mm, between 100 microns and 30 mm, between 100 microns and 25.4 mm, between 100 microns and 20 mm, between 100 microns and 10 mm, between 100 microns and 1.0 mm, between 100 microns and 500 microns, between 100 microns and 200 microns, between 20 microns and 100 microns, or between 20 microns and 50 microns. It can be appreciated that fine fiber layers of filter media described herein may have thicknesses outside of the above noted ranges.

It may be preferable for the filter media to exhibit certain mechanical properties. For instance, a nonwoven filter media in accordance with the present disclosure may exhibit both enhanced performance characteristics and favorable mechanical properties. Such a nonwoven filter media may exhibit a high gamma (e.g., gamma greater than 12) and a relatively high tensile strength (e.g., MD tensile strength of greater than 3.0 lbs/inch, or between 3.0 lbs/inch and 200 lbs/inch) and/or stiffness (e.g., gurley stiffness of greater than 400 gu, or between 400 gu and 3000 gu), particularly when compared with more conventional nonwoven filter media. In some embodiments, certain mechanical properties (e.g., tensile strength, stiffness) of the filter media are enhanced with the addition of a supporting structure, such as a metal or polymeric mesh and/or woven material.

The tensile strength properties of the filter media may vary appropriately. Tensile strength is measured in accordance with TAPPI 494.

In some embodiments, the nonwoven filter media may have a tensile strength in the machine direction of greater than 1.0 lb/inch, greater than 2.0 lbs/inch, greater than 3.0 lbs/inch, greater than 5.0 lbs/inch, greater than 10 lbs/inch, greater than 20 lbs/inch, greater than 30 lbs/inch, greater than 40 lbs/inch, greater than 50 lbs/inch, greater than 60 lbs/inch, greater than 70 lbs/inch, greater than 80 lbs/inch, greater than 90 lbs/inch, greater than 100 lbs/inch, or greater than 150 lbs/inch. Alternatively, the nonwoven filter media may have a tensile strength in the machine direction of between 1.0 lb/inch and 200 lbs/inch, between 1.0 lb/inch and 150 lbs/inch, between 1.0 lb/inch and 100 lbs/inch, between 1.0 lb/inch and 50 lbs/inch, between 1.0 lbs/inch and 20 lbs/inch, between 1.0 lb/inch and 10 lbs/inch, between 3.0 lbs/inch and 200 lbs/inch, between 3.0 lbs/inch and 150 lbs/inch, between 3.0 lbs/inch and 100 lbs/inch, between 3.0 lbs/inch and 50 lbs/inch, between 3.0 lbs/inch and 20 lbs/inch, between 3.0 lbs/inch and 10 lbs/inch, between 5.0 lbs/inch and 200 lbs/inch, between 5.0 lbs/inch and 150 lbs/inch, between 5.0 lbs/inch and 100 lbs/inch, between 5.0 lbs/inch and 50 lbs/inch, between 5.0 lbs/inch and 20 lbs/inch, between 5.0 lbs/inch and 10 lbs/inch, between 20 lbs/inch and 200 lbs/inch, between 100 lbs/inch and 200 lbs/inch, between 150 lbs/inch and 200 lbs/inch, between 20 lbs/inch and 150 lbs/inch, between 20 lbs/inch and 50 lbs/inch, between 50 lbs/inch and 100 lbs/inch, between 100 lbs/inch and 150 lbs/inch, between 20 lbs/inch and 100 lbs/inch, or between 20 lbs/inch and 50 lbs/inch. It should be understood that filter media described herein may have a tensile strength in the machine direction outside of the above noted ranges.

As discussed above, the tensile strength of the overall filter media in the machine direction may be increased by suitably adding a supporting structure, for example, a metal or polymeric mesh and/or woven material to the nonwoven portion(s) of the filter media. For instance, a filter media, having a metal or polymeric mesh and/or woven material mounted or placed thereon, may have a tensile strength in the machine direction of greater than 1.0 lb/inch, greater than 2.0 lbs/inch, greater than 3.0 lbs/inch, greater than 5.0 lbs/inch, greater than 10 lbs/inch, greater than 20 lbs/inch, greater than 30 lbs/inch, greater than 40 lbs/inch, greater than 50 lbs/inch, greater than 60 lbs/inch, greater than 70 lbs/inch, greater than 80 lbs/inch, greater than 90 lbs/inch, greater than 100 lbs/inch, greater than 150 lbs/inch, greater than 200 lbs/inch, or greater than 250 lbs/inch. Or, the filter media, including the metal/polymeric mesh and/or woven material, may have a tensile strength in the machine direction of between 1.0 lb/inch and 300 lbs/inch, between 1.0 lb/inch and 250 lbs/inch, between 1.0 lb/inch and 200 lbs/inch, between 1.0 lb/inch and 150 lbs/inch, between 1.0 lb/inch and 100 lbs/inch, between 1.0 lb/inch and 50 lbs/inch, between 1.0 lbs/inch and 20 lbs/inch, between 1.0 lb/inch and 10 lbs/inch, between 3.0 lbs/inch and 300 lbs/inch, between 3.0 lbs/inch and 200 lbs/inch, between 3.0 lbs/inch and 150 lbs/inch, between 3.0 lbs/inch and 100 lbs/inch, between 3.0 lbs/inch and 50 lbs/inch, between 3.0 lbs/inch and 20 lbs/inch, between 3.0 lbs/inch and 10 lbs/inch, between 5.0 lbs/inch and 300 lbs/inch, between 5.0 lbs/inch and 200 lbs/inch, between 5.0 lbs/inch and 150 lbs/inch, between 5.0 lbs/inch and 100 lbs/inch, between 5.0 lbs/inch and 50 lbs/inch, between 5.0 lbs/inch and 20 lbs/inch, between 5.0 lbs/inch and 10 lbs/inch, between 20 lbs/inch and 300 lbs/inch, between 20 lbs/inch and 200 lbs/inch, between 20 lbs/inch and 150 lbs/inch between 20 lbs/inch and 100 lbs/inch, or between 20 lbs/inch and 50 lbs/inch. The overall filter media described herein may have a tensile strength in the machine direction outside of the above noted ranges.

The nonwoven filter media may have any suitable stiffness properties. In some embodiments, the nonwoven filter media may have a stiffness of greater than 50 gu, greater than 100 gu, greater than 200 gu, greater than 300 gu, greater than 400 gu, greater than 500 gu, greater than 600 gu, greater than 700 gu, greater than 800 gu, greater than 900 gu, or greater than 1000 gu, greater than 1500 mg, greater than 2000 gu, or greater than 2500 gu. For example, the nonwoven filter media may have a stiffness of between 50 gu and 3000 gu, between 60 gu and 3000 gu, between 70 gu and 3000 gu, between 80 gu and 3000 gu, between 90 gu and 3000 gu, between 100 gu and 3000 gu, between 200 gu and 3000 gu, between 300 gu and 3000 gu, between 400 gu and 3000 gu, between 500 gu and 3000 gu, between 600 gu and 3000 gu, between 700 gu and 3000 gu, between 800 gu and 3000 gu, between 900 gu and 3000 gu, between 1000 gu and 3000 gu, between 2000 gu and 3000 gu, between 50 gu and 2000 gu, between 60 gu and 2000 gu, between 70 gu and 2000 gu, between 80 gu and 2000 gu, between 90 gu and 2000 gu, between 100 gu and 2000 gu, between 200 gu and 2000 gu, between 300 gu and 2000 gu, between 400 gu and 2000 gu, between 500 gu and 2000 gu, between 600 gu and 2000 gu, between 700 gu and 2000 gu, between 800 gu and 2000 gu, between 900 gu and 2000 gu, or between 1000 gu and 2000 gu. Nonwoven filter media described herein may have stiffness values outside of the above noted ranges.

As also discussed, the stiffness of the overall filter media may be increased by suitably adding a supporting structure, such as a metal or polymeric mesh and/or woven material to the nonwoven portion(s) of the filter media. For instance, a filter media, having a metal/polymeric mesh and/or woven material mounted or placed thereon, may have a stiffness of greater than 50 gu, greater than 100 gu, greater than 200 gu, greater than 300 gu, greater than 400 gu, greater than 500 gu, greater than 600 gu, greater than 700 gu, greater than 800 gu, greater than 900 gu, greater than 1000 gu, greater than 1500 gu, greater than 2000 gu, greater than 2500 gu, greater than 3000 gu, or greater than 3500 gu. Or, the filter media, with a metal/polymeric mesh and/or woven material, may have a stiffness of between 50 gu and 4000 gu, between 100 gu and 4000 gu, between 200 gu and 4000 gu, between 300 gu and 4000 gu, between 400 gu and 4000 gu, between 500 gu and 4000 gu, between 600 gu and 4000 gu, between 700 gu and 4000 gu, between 800 gu and 4000 gu, between 900 gu and 4000 gu, between 1000 gu and 4000 gu, between 2000 gu and 4000 gu, between 3000 gu and 4000 gu, between between 50 gu and 3000 gu, between 60 gu and 3000 gu, between 70 gu and 3000 gu, between 80 gu and 3000 gu, between 90 gu and 3000 gu, between 100 gu and 3000 gu, between 200 gu and 3000 gu, between 300 gu and 3000 gu, between 400 gu and 3000 gu, between 500 gu and 3000 gu, between 600 gu and 3000 gu, between 700 gu and 3000 gu, between 800 gu and 3000 gu, between 900 gu and 3000 gu, between 1000 gu and 3000 gu, between 2000 gu and 3000 gu, between 50 gu and 2000 gu, between 60 gu and 2000 gu, between 70 gu and 2000 gu, between 80 gu and 2000 gu, between 90 gu and 2000 gu, between 100 gu and 2000 gu, between 200 gu and 2000 gu, between 300 gu and 2000 gu, between 400 gu and 2000 gu, between 500 gu and 2000 gu, between 600 gu and 2000 gu, between 700 gu and 2000 gu, between 800 gu and 2000 gu, between 900 gu and 2000 gu, or between 1000 gu and 2000 gu. The overall filter media described herein may have a stiffness that falls outside of the above noted ranges.

Stiffness measurements of the present disclosure are measured as Gurley stiffness (bending resistance) recorded in units of gu (equivalent to milligrams) for dry filter media in the machine direction, in accordance with TAPPI T543 om-94.

It can be appreciated that filter media in accordance with the present disclosure may exhibit other mechanical properties that may provide advantage over the existing art.

Filter media in accordance with the present disclosure may exhibit certain filtration performance properties.

For instance, the filter media may be characterized by penetration, often expressed as a percentage, defined as follows:

% Penetration=C/C₀*100

where C is the concentration of particles measured after passage through the filter media and C₀ is the concentration of particles measured before passage through the filter media. Filter efficiency is defined as follows:

% Efficiency=100−% Penetration

Typical tests of penetration/efficiency involve flowing small particles through a filter media and measuring the percentage of particles that pass through the filter media. As determined herein, the initial penetration test for efficiency (“lower efficiency test”) is carried out using an ATI 100P penetrometer and involves exposing the filter media to DOP aerosol particles approximately 0.3 microns in diameter at a face velocity through the filter media of approximately 5.3 cm/sec. If the efficiency of the filter media is measured to be less than or equal to 90%, then this value measured is determined to be the efficiency of the filter media and, in some cases, may be categorized as a filter media suitable for ASHRAE applications. For efficiency levels measured to be greater than 90%, a subsequent penetration test, appropriate for higher efficiency filter media, is employed. This subsequent penetration test (“higher efficiency test”) is carried out using a TSI 3160 penetrometer and the filter media is subject to particles having a size of approximately 0.12 microns in diameter traveling at a face velocity through the filter media of approximately 2.5 cm/sec.

As discussed, filter media described herein may be used for a wide range of applications that may require a certain level of efficiency.

In some cases, the type of application for which a filter media may be used may be determined, in part, by the filtration performance of the filter media. For example, filter media in accordance with the present disclosure may be categorized according to the highest EN1822 filter classification (e.g., ultra-low penetration air (ULPA)) and, accordingly, may exhibit efficiencies between 99.95% and 99.999995%, as measured by the higher efficiency test. Or, the filter media may be suitable for HVAC applications, which is categorized according to an efficiency between 70-80%, as measured by the lower efficiency test. For HEPA applications, the filter media exhibits an efficiency of greater than 90%, as measured by the higher efficiency test.

Or, filter media described herein may exhibit a comparatively low efficiency, for example, between 2% and 20%, as measured by the lower efficiency test. In some embodiments, using the appropriate lower and/or higher efficiency test, the filter media may exhibit an efficiency of between 2% and 99.9999995%, between 5% and 99.9999995%, between 10% and 99.9999995%, between 20% and 99.9999995%, between 30% and 99.9999995%, between 40% and 99.9999995%, between 50% and 99.9999995%, between 60% and 99.9999995%, between 70% and 99.9999995%, between 80% and 99.9999995%, between 90% and 99.9999995%, between 95% and 99.9999995%, between 99.9% and 99.9999995%, between 99.95% and 99.9999995%, between 9.995% and 99.9999995%, between 99.9995% and 99.9999995%, between 99.99995% and 99.9999995%, between 99.999995% and 99.9999995%, between 2% and 99.999995%, between 5% and 99.999995%, between 10% and 99.999995%, between 20% and 99.999995%, between 30% and 99.999995%, between 40% and 99.999995%, between 50% and 99.999995%, between 60% and 99.999995%, between 70% and 99.999995%, between 80% and 99.999995%, between 90% and 99.999995%, between 95% and 99.999995%, between 99.9% and 99.999995%, between 99.95% and 99.999995%, between 9.995% and 99.999995%, between 99.9995% and 99.999995%, between 99.99995% and 99.9999995%, between 2% and 50%, between 5% and 50%, between 10% and 50%, between 20% and 50%, between 30% and 50%, between 40% and 50%, between 50% and 99%, between 50% and 99%, between 60% and 99%, between 70% and 99%, between 80% and 99%, between 90% and 99%, between 95% and 99%, between 95% and 99.99%, or between 95% and 99.9%. It can be appreciated that filter media described herein may exhibit any appropriate range of efficiency, which may be application-dependent, including efficiency levels outside of the above-noted ranges.

As noted herein, the percent penetration of small particles through the filter media (i.e., efficiency of the filter media) may be generally related to the size of the glass fibers within the filter media. For example, incorporating finer fibers (higher surface area) in one or more layers of a filter media may give rise to a decreased penetration percentage (i.e., higher efficiency), while incorporating coarser fibers (lower surface area) in one of more layers of the filter media may give rise to an increased penetration percentage (i.e., lower efficiency).

The pressure drop, also referred to as flow resistance, across the filter media is measured based on the above described air penetration/efficiency test using the ATI 100P penetrometer. Unless otherwise noted, pressure drop as discussed herein is the initial pressure drop measured upon commencement of the lower efficiency test described above. In some embodiments, the initial pressure drop across the filter media during testing is less than 200 mm of H₂O, less than 150 mm of H₂O, less than 100 mm of H₂O, less than 50 mm of H₂O, less than 10 mm of H₂O, less than 5.0 mm of H₂O, less than 1.0 mm of H₂O, or less than 0.5 mm of H₂O. For example, the initial pressure drop across the filter media during testing may be between 0.1 mm H₂O and 200 mm H₂O, between 0.5 mm H₂O and 200 mm H₂O, between 1.0 mm H₂O and 200 mm H₂O, between 5.0 mm H₂O and 200 mm H₂O, between 10 mm H₂O and 200 mm H₂O, between 20 mm H₂O and 200 mm H₂O, between 50 mm H₂O and 200 mm H₂O, between 100 mm H₂O and 200 mm H₂O, between 0.1 mm H₂O and 100 mm H₂O, between 0.5 mm H₂O and 100 mm H₂O, between 1.0 mm H₂O and 100 mm H₂O, between 5.0 mm H₂O and 100 mm H₂O, between 10 mm H₂O and 100 mm H₂O, between 20 mm H₂O and 100 mm H₂O, between 50 mm H₂O and 100 mm H₂O, between 0.1 mm H₂O and 50 mm H₂O, between 0.5 mm H₂O and 50 mm H₂O, between 1.0 mm H₂O and 50 mm H₂O, between 5.0 mm H₂O and 50 mm H₂O, between 10 mm H₂O and 50 mm H₂O, or between 20 mm H₂O and 50 mm H₂O, between 0.1 mm H₂O and 10 mm H₂O, between 0.2 mm H₂O and 5.0 mm H₂O, between 0.3 mm H₂O and 1.0 mm H₂O, between 0.4 mm H₂O and 0.8 mm H₂O, between 10 mm H₂O and 100 mm H₂O, between 20 mm H₂O and 80 mm H₂O, between 30 mm H₂O and 70 mm H₂O, between 40 mm H₂O and 60 mm H₂O, between 50 mm H₂O and 150 mm H₂O, between 60 mm H₂O and 140 mm H₂O, between 70 mm H₂O and 130 mm H₂O, between 80 mm H₂O and 120 mm H₂O, or between 90 mm H₂O and 110 mm H₂O. It can be appreciated that filter media described herein may exhibit any suitable range of initial pressure drop, including values of pressure drop outside of the above-noted ranges.

For filtration applications, it is often useful to rate various filter media based on the relationship between penetration and pressure drop across the filter media. Accordingly, filter media may be rated according to gamma, which is expressed according to the following formula:

gamma=[−log(% penetration/100)/pressure drop, mm H₂O]*100

In general, it is desirable for the pressure drop across the filter media to be low, allowing for fluid to flow through the filter media; at the same time, it is also desirable for the filter media to exhibit a relatively high efficiency, where dust particles are trapped and prevented from penetrating through the filter media. Based on the formula above, gamma is increased when the pressure drop across the filter media is reduced, and gamma is also increased when the efficiency of the filter media is raised. Accordingly, steeper slopes, or higher gamma values, in accordance with the above relationship, are indicative of better filter performance.

Filter media in accordance with the present disclosure may have an appropriately high gamma, as calculated from values of efficiency and initial pressure drop measured using the penetration test(s) described above. That is, in determining gamma, when the efficiency measured using the lower efficiency test is less than or equal to 90%, values of efficiency and initial pressure drop, both measured from the lower efficiency test, are input into the gamma calculation. Though, when the efficiency measured using the lower efficiency test is greater than 90%, the value of efficiency measured from the higher efficiency test and the value of initial pressure drop measured from the lower efficiency test are input into the gamma calculation. In some embodiments, the gamma values for the filter media are greater than 4, greater than 5, greater than 6, greater than 7, greater than 8, greater than 10, greater than 12, greater than 14, greater than 16, greater than 18, greater than 20, greater than 22, or greater than 24. In some cases, gamma values for filter media described herein may be between 2 and 25, between 10 and 25, between 15 and 25, between 20 and 25, between 2 and 20, between 4 and 20, between 6 and 20, between 8 and 20, between 10 and 20, between 12 and 20, between 14 and 20, between 16 and 20, between 2 and 16, between 4 and 16, between 6 and 16, between 8 and 16, between 10 and 16, between 12 and 16, between 2 and 12, between 4 and 12, between 6 and 12, between 8 and 12, between 10 and 12, between 2 and 8, between 4 and 8, or between 6 and 8. It should be appreciated that the filter media may exhibit gamma values outside of the above-noted ranges.

Filter media described herein may exhibit an appropriate dust holding capacity. The dust holding capacity is the difference in the weight of the filter media before exposure to a certain amount of fine dust and the weight of the filter media after the exposure to the fine dust, upon reaching a particular pressure drop across the filter media, divided by the area of the fiber web. Dust holding capacity may be determined according to the weight (mg) of dust captured per square cm of the media (e.g., through a 100 cm² test area). As determined herein, dust holding capacity is measured using an ASHRAE 52.2 flat sheet test rig tested at 15 fpm velocity where the final pressure drop when the dust holding capacity is measured is 1.5 inches of H₂O on a column. While not precluding measurements of dust holding capacity for other filtration applications, it can be appreciated that this test for dust holding capacity may be particularly applicable for filter media that exhibit an efficiency of less than or equal to 90%.

In some embodiments, the dust holding capacity of the filter media may be greater than 5 g/m², greater than 10 g/m², greater than 20 g/m², greater than 30 g/m², greater than 40 g/m², or greater than 50 g/m², greater than 100 g/m², greater than 150 g/m², greater than 200 g/m², greater than 250 g/m², greater than 300 g/m², greater than 400 g/m², greater than 500 g/m², greater than 600 g/m², greater than 700 g/m², greater than 800 g/m², or greater than 900 g/m². Or, the dust holding capacity of the filter media may be between 5 g/m² and 1000 g/m², between 5 g/m² and 900 g/m², between 5 g/m² and 800 g/m², between 5 g/m² and 700 g/m², between 5 g/m² and 600 g/m², between 5 g/m² and 500 g/m², between 5 g/m² and 400 g/m², between 5 g/m² and 300 g/m², between 100 g/m² and 700 g/m², between 200 g/m² and 600 g/m², between 200 g/m² and 400 g/m², between 400 g/m² and 600 g/m², between 10 g/m² and 300 g/m², between 20 g/m² and 300 g/m², or between 50 g/m² and 300 g/m², between 100 g/m² and 300 g/m², between 150 g/m² and 300 g/m², between 200 g/m² and 300 g/m², between 5 g/m² and 200 g/m², between 10 g/m² and 200 g/m², between 20 g/m² and 200 g/m², between 50 g/m² and 200 g/m², between 100 g/m² and 200 g/m², between 150 g/m² and 200 g/m², between 5 g/m² and 50 g/m², between 10 g/m² and 40 g/m², between 20 g/m² and 30 g/m², between 30 g/m² and 50 g/m², between 40 g/m² and 50 g/m², between 50 g/m² and 150 g/m², between 70 g/m² and 130 g/m², between 90 g/m² and 110 g/m², between 150 g/m² and 300 g/m², between 180 g/m² and 250 g/m², or between 200 g/m² and 230 g/m². The filter media may exhibit dust holding capacity values outside of the above-noted ranges.

The filter media may exhibit suitable air permeability characteristics. As determined herein, the permeability is measured according to ASTM D737 with a Frazier Permeability Tester. In some embodiments, the air permeability of the filter media may be greater than 0.5 cubic feet per minute per square foot (cfm/sf), greater than 0.6 cfm/sf, greater than 1.0 cfm/sf, greater than 1.3 cfm/sf, greater than 1.5 cfm/sf, greater than 2.0 cfm/sf, greater than 5.0 cfm/sf, greater than 10 cfm/sf, greater than 20 cfm/sf, greater than 30 cfm/sf, greater than 40 cfm/sf, greater than 50 cfm/sf, greater than 100 cfm/sf, greater than 200 cfm/sf, greater than 500 cfm/sf, greater than 700 cfm/sf, greater than 1000 cfm/sf, or greater than 1300 cfm/sf. Alternatively, the air permeability of the filter media may be between 0.5 cfm/sf and 1500 cfm/sf, between 0.6 cfm/sf and 1350 cfm/sf, between 1.0 cfm/sf and 1000 cfm/sf, or between 1.3 cfm/sf and 300 cfm/sf. The filter media may exhibit air permeability characteristics outside of the above-noted ranges.

The fine fiber layer of the filter media may also exhibit suitable air permeability characteristics. Tested independently of the filter media in which the fine fiber layer is incorporated, in some embodiments, the air permeability of the fine fiber layer may be between 0.1 cfm/sf and 1500 cfm/sf, between 0.2 cfm/sf and 1000 cfm/sf, between 0.5 cfm/sf and 1000 cfm/sf, or between 1.0 cfm/sf and 500 cfm/sf. The fine fiber layer may exhibit air permeability characteristics outside of the above-noted ranges.

Filter media described herein may be produced using any suitable method. In some embodiments, individual layers of the filter media may be separately formed using nonwoven, wet-laid processing techniques, or other appropriate methods.

In some embodiments, the controlled layering of multiple fine fiber layers in accordance with the present disclosure over one another on a substrate results in filter media exhibiting higher gamma values as compared, for example, with filter media that incorporate a single layer that includes a blend of fine and coarse glass fibers.

Layers of filter media described herein may be formed continuously along the same machine line, or may be separately formed from one another (e.g., on separate forming machines/wires or in separate production runs) and then laminated or placed together. As a result, individual layers of the filter media may each be tuned according to desired processing conditions and material combinations to have particular properties.

For instance, in conventional forming processes, the addition of a binder composition (e.g., latex resin) to the filter media, whether applied by spray, vacuum and/or other processes, may occur on the surface of a forming wire after exit of fiber slurries from a headbox or pressure former. Thus, the binder composition permeates throughout the entire filter media during or after formation.

However, in accordance with the present disclosure, the addition of a binder composition may occur further upstream, before formation of the fiber web on a wire, such as during the headbox mixing stage and, in some cases, prior to the headbox mixing stage (e.g., via beater addition process). Accordingly, using methods described herein, the application of a binder, or any other component (e.g., fluorochemical, organosilicon, etc.), to one or more layers of the filter media may be controlled, separately from the other layer(s), with only a small amount, if any, of cross-migration of contents between different layers during or after formation. As a result, by allowing the binder composition to be separated from the fine fiber layer(s) and incorporated within the substrate(s), filter media in accordance with the present disclosure may be produced so as to exhibit high gamma in addition to good mechanical properties, for example, mechanical properties that allow the filter media to be pleated. Thus, the beneficial effects of the binder in providing for pleatability of the filter media may be maintained while reducing, or substantially eliminating, detrimental effects of the binder that would otherwise reduce the gamma of the filter media.

In some embodiments, one or more layers of the filter media may be produced by mixing fine glass fibers and other components in an aqueous solution, to form a slurry of fine glass fibers. The slurry of fine glass fibers may then be suitably dewatered and dried on the surface of a forming wire. For example, fine glass fibers may be combined with one or more components (e.g., fluorochemical, organosilicon components) to form a fiber slurry that acts as a precursor for a fine fiber layer.

In some embodiments, in addition to formation of a fine fiber layer, a blend of fibers (e.g., fine glass, coarse glass, synthetic fibers) may be mixed together with various components (e.g., binder resin) into a respective fiber slurry in forming a precursor for a substrate, or substrate layer for forming a substrate. The substrate and one or more fine fiber layers may be combined into a filter media having advantageous properties.

In some embodiments, once the first layer is appropriately formed, the second layer may be formed directly on the first layer; for example, the first and second layers may be formed along the same line as one another. In some embodiments, the substrate layer(s) and the fine fiber layer(s) are formed along the same line in a continuous fashion. That is, as appreciated by those of skill in the art, a substrate layer, or other appropriate layer, may be formed on the surface of a wire of a paper-making machine; and a fine fiber layer, or other appropriate layer, may be formed on the same paper-making machine, on the same or a different wire of the paper-making machine. Alternatively, the substrate may be a pre-manufactured fiber web and the fine fiber layer(s) may be placed on or otherwise positioned over the substrate.

As discussed above, while the substrate of the filter media may include any suitable combination of components, such as glass fibers, synthetic fibers, binder compositions, additives, etc., in some embodiments, the fine fiber layer of the filter media may include fine glass fibers, with other components (e.g., fluorochemical and organosilicon compositions), yet only a small amount of binder composition, if any.

Accordingly, methods described herein may provide for the ability to form a substrate layer, or other layer of the filter media, which may include a suitable amount of binder composition, and one or more fine fiber layers, which may be substantially free of binder composition. While formation of the substrate layer(s) and the fine fiber layer(s) may occur along a continuous line on the same machine system, there is little to no cross-contamination from the substrate layer(s) to the fine fiber layer(s) or, in some cases, vice versa.

Producing a filter media having multiple layers that are formed along the same continuous line (e.g., forming wire/machine), or separately formed (e.g., formed on different wires/machines), may have certain advantages. For example, each layer may be subject to independent treatments and/or inclusion of one or more components without necessarily affecting other layers of the filter media.

For some embodiments, as discussed above, it may be desirable that the substrate function as a base layer that is relatively open (e.g., open nonwoven scrim), yet exhibit a certain degree of pleatability as well as provide support for the fine fiber layer. Thus, it may be desirable that the substrate include a binder composition.

It may also be desirable that the fine fiber layer function as an efficiency layer, allowing fluid flow therethrough while also trapping small dust particles. Accordingly, it may be preferred that the fine fiber layer include fluorochemical and/or organosilicon compositions, yet may also be substantially free of binder composition, which could otherwise block fluid (e.g., air, liquid) flow, giving rise to an increase in pressure drop.

In some embodiments, the fine fiber layer(s) and/or the substrate layer(s) may be formed using a wet laid process, using equipment suitable for papermaking, for example, a hydropulper, a former (e.g., pressure former) or a headbox, a dryer and/or a converter. For example, in forming each of the fine fiber layer(s) and/or the substrate layer(s), a slurry or fiber mixture may be prepared in one or more pulpers. The fiber mixture may be subject to a beater addition process within the pulper(s) or after exit from the pulper(s), to form an appropriate suspension. The fiber mixture (or suspension thereof) may be pumped into a headbox or pressure former, where the mixture may or may not be combined with other mixtures, or additives may or may not be added.

It can be appreciated that filter media described herein may be fabricated according to any suitable combination of fabrication techniques, examples of which are described below.

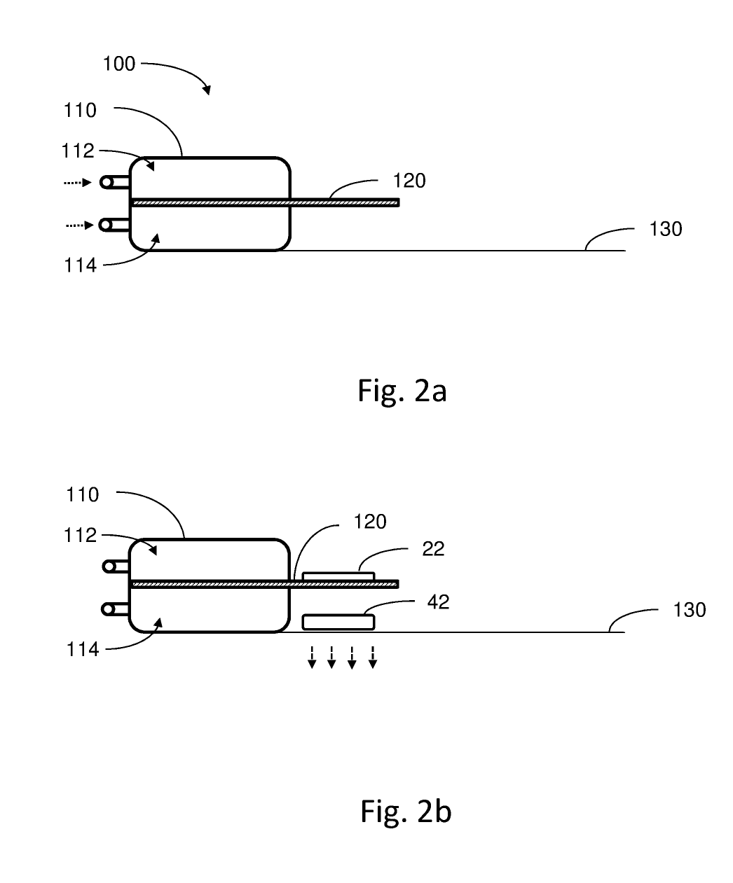

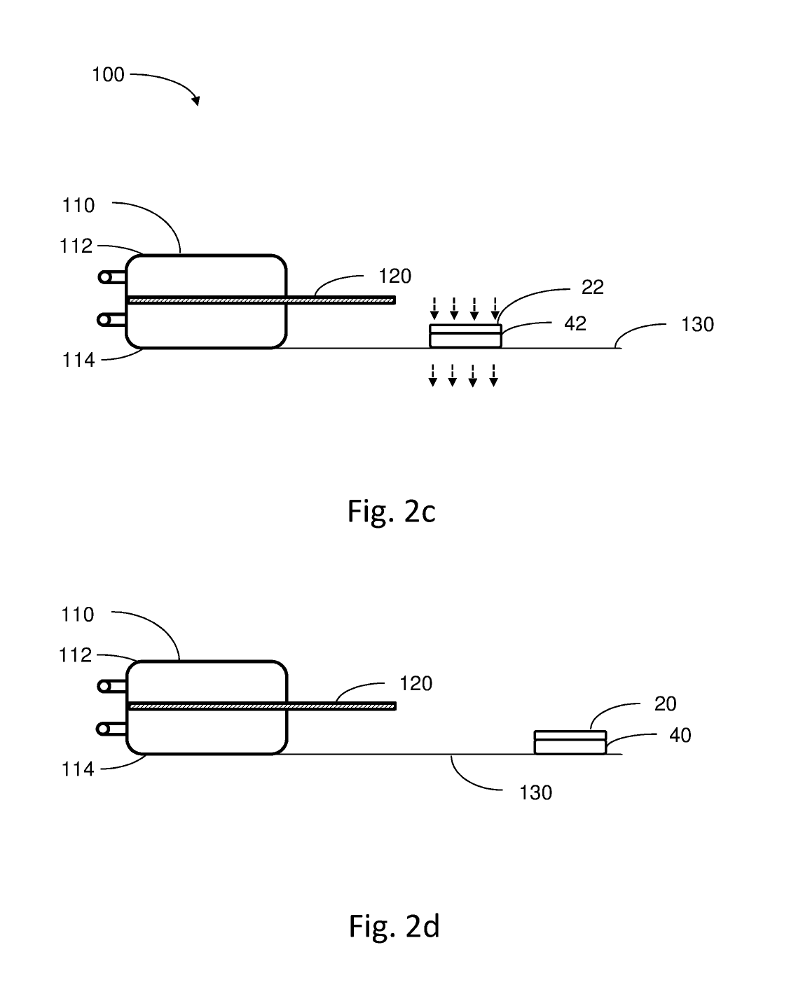

In some embodiments, the filter media is produced via a multi-ply pressure former headbox. A schematic non-limiting example of a two-ply pressure former headbox is shown in use in FIGS. 2a-2d. As depicted, the forming system 100 includes a multi-ply pressure former 110 having two compartments 112, 114 in which respective glass fiber slurries are mixed. As described further below, the contents within the respective compartments may be subject to an appropriate beater addition process (not shown in the figures) prior to entry into the pressure former (or other suitable headbox), or within the compartment(s) of the pressure former itself.

The dotted arrows of FIG. 2a illustrate entry of contents of a fiber mixture into respective compartments of the pressure former. It may be desirable for the mixture entering into the pressure former or other suitable headbox to maintain an even consistency during agitation and formation. Thus, for example, upon entry into the pressure former, the mixture may be divided into multiple inlets (not shown) through which the mixture is injected into appropriate compartments of the pressure former.

The compartments 112, 114 of the pressure former 110 are separated by a lamella 120, which serves to separate material contained within respective compartments. Once ready for the forming process, as shown in FIG. 2b, respective fiber layers 22, 42 exit out of respective compartments of the pressure former 110. In some embodiments, as shown, the lamella 120 may optionally extend further downstream from the pressure former, so as to further safeguard against mixing of components between the two aqueous slurries. As a result, in the embodiment shown, the fiber layer 42 exits directly on to the surface of a forming wire 130 while the fiber layer 22 remains on the lamella 120, separate from the fiber layer 42.

The lower fiber layer 42, to be formed as a substrate layer of the filter media, is subject to dewatering via vacuum drying downward prior to formation of the upper fiber layer 22, which is to be formed as an efficiency layer of the filter media. The lower fiber layer 42 is dewatered in a downward direction, as shown by the dashed arrows. Accordingly, the contents of the lower fiber layer 42 are immobilized, due to dewatering and at least partial drying, reducing the possibility for such contents to migrate into the upper fiber layer 22.

As shown in FIG. 2c, the fiber layers 22, 42 are allowed to travel further downstream appropriately along the forming wire 130 and past the end of the lamella 120 such that the upper fiber layer 22 is deposited on to the lower fiber layer 42. With the lower fiber layer 42 having already been subject to an appropriate degree of dewatering, the upper fiber layer 22 may then be suitably dewatered. As such, both fiber layers 22, 42 are dewatered in a downward direction at the same time, as depicted by the dashed arrows.

In some embodiments, it may be desirable for certain contents (e.g., binder compositions) of the lower fiber layer 42 to be kept from the upper fiber layer 22; though, it may be permissible for contents of the upper fiber layer 22 to seep or otherwise migrate into the lower fiber layer 42 (e.g., fluorochemical, organosilicon compositions). Depending on the end-use application of the filter media, it can be appreciated that each of the various layers that are formed along the same continuous line, or separately formed and then laminated or otherwise adhered together, may be appropriately tailored to include any suitable combination of components.

As both layers are suitably dewatered and formed, for example, on a forming wire or screen, the fine fiber layer 20 may be appropriately adhered to or otherwise positioned over the substrate layer 40, as shown in FIG. 2d, to form the filter media.

In some embodiments, during or after dewatering, a wet-laid fiber web may be passed over a series of drum dryers to dry at an appropriate temperature (e.g., about 275° F. to 325° F., or any other temperature suitable for drying). For some cases, typical drying times may vary until the moisture content of the composite fiber is as desired. In some embodiments, drying of the wet-laid fiber web(s) may be performed using infrared heaters. In some cases, drying will aid in curing the fiber web(s). In addition, the dried fiber web(s) may be appropriately reeled up for downstream filter media processing.

Alternatively, in some embodiments, the filter media may be produced using an arrangement that employs multiple headboxes positioned at suitable locations along the forming line.

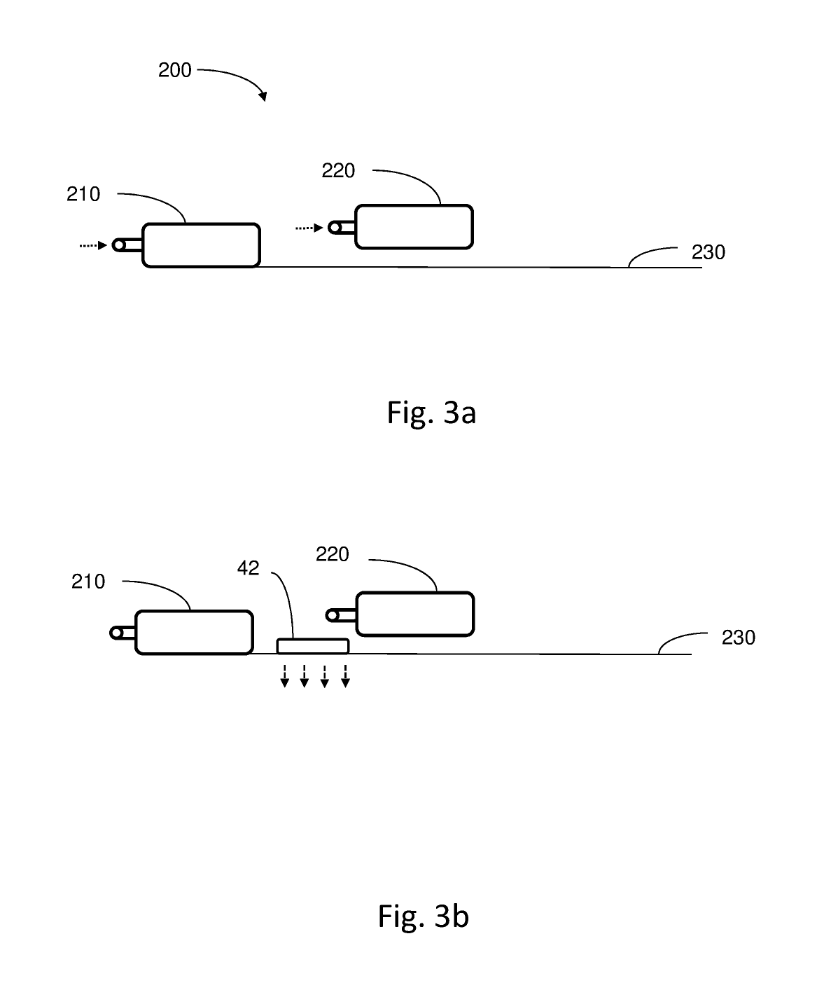

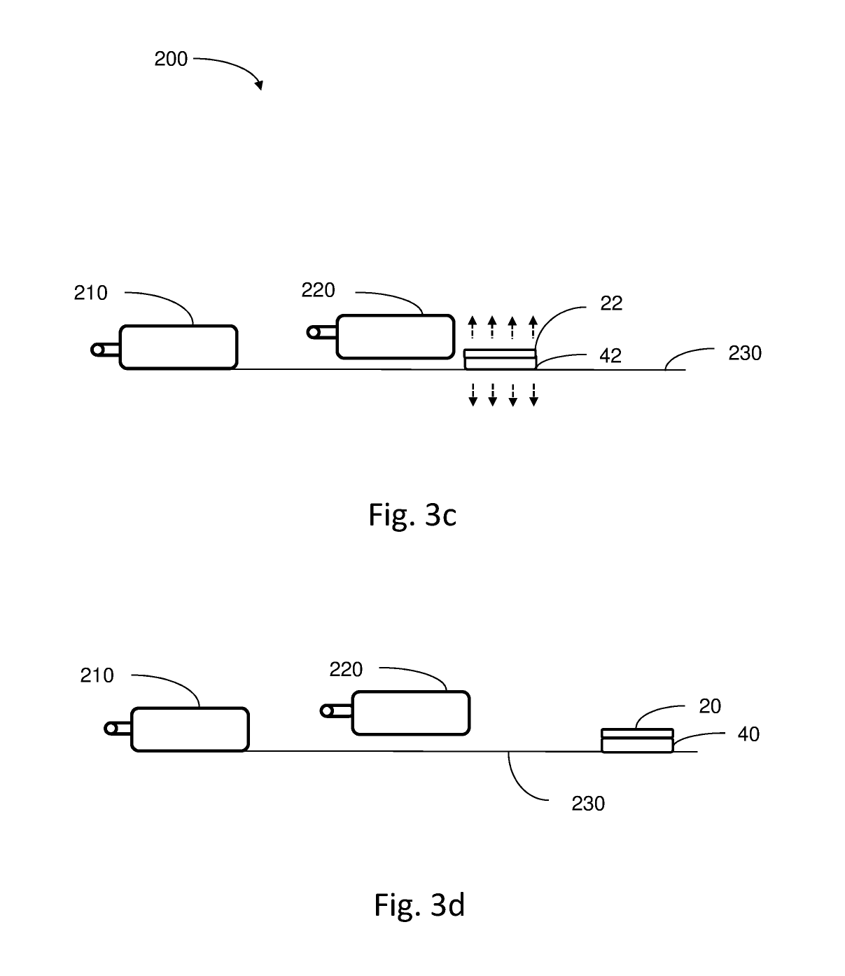

FIGS. 3a-3d depict a schematic non-limiting example of a forming system 200 that includes a primary headbox 210 positioned at a first location along a continuous forming line, and a secondary headbox 220 positioned at a second location along the same forming line, downstream from the first location. Each headbox 210, 220 includes a compartment within which respective glass fiber mixtures are introduced and agitated. As discussed above, the contents within each of the headboxes may be subject to an appropriate beater addition process prior to entry into the headbox, or within the headbox itself.

FIG. 3a depicts dotted arrows which illustrate entry of contents of a fiber mixture (e.g., fiber glass slurry) into respective headboxes. For mixtures entering into respective headboxes to maintain a suitably even consistency during agitation and formation, if preferred, multiple inlets (not shown) through which corresponding fiber mixtures enter may be provided for each headbox.

In some embodiments, the primary headbox 210 may include a mixture of components used to form a substrate layer (e.g., base layer, scrim, backing, etc.); and the secondary headbox 220 may include a mixture of components used to form a fine fiber layer (e.g., efficiency layer, etc.). When appropriately mixed and ready for forming (e.g., on a wire or screen), each of the fiber slurries exits the headbox and is formed on to the surface of a forming wire 230 at suitable locations thereon.

FIG. 3b shows a lower fiber layer 42, which is to be formed as a substrate layer of the filter media, having exited from the primary headbox 210. The lower fiber layer 42 is subject to downward dewatering by vacuum, prior to exit of the upper fiber layer 22 from the secondary headbox. The lower fiber layer 42 is dewatered in a downward direction, as illustrated by the dashed arrows.

In some embodiments, the secondary headbox 220 is located in the forming area downstream of the primary headbox 210 where the lower fiber layer 42 is suitably consolidated on the forming wire 230, for example, such that a substantially dry fiber web has formed. In some cases, it may be preferable for the upper fiber layer 22, which is to be formed as the fine fiber layer, to be deposited on to the lower fiber layer 42 only after the lower fiber layer 42 is suitably dry, so as to reduce chances that components from the lower fiber layer 42 migrate into the upper fiber layer 22.

As shown in FIG. 3c, the lower fiber layer 42 has traveled further downstream along the forming wire 230 and, upon sufficient dewatering (e.g., such that the contents of the lower fiber layer are suitably immobilized), the upper fiber layer 22 exits from the secondary headbox 220 and is deposited on to the first fiber layer.

In this embodiment, the upper fiber layer 22 is subject to dewatering in an upward direction, shown by the dashed arrows, by a vacuum applied from a top former (not shown). Accordingly, both fiber layers 22, 42 are dewatered simultaneously, in different directions, further reducing the chances for co-mingling of contents within each of the fiber layers. It can be appreciated that, in some cases, it may be preferable for both fiber layers to be dewatered in the same direction and/or for a top former not to be employed.

As shown in FIG. 3d, when both layers are suitably dewatered and formed, the fine fiber layer 20 may be appropriately adhered to or otherwise positioned over the substrate layer 40, to form the filter media.

It can be appreciated that various combinations of methods described herein may be used. For example, a multi-ply pressure former may be used in conjunction with a secondary headbox, disposed downstream the multi-ply pressure former. Or, even more headboxes, pressure formers, vacuum boxes, top formers, beater addition compartments, supply lines/conduits, etc., may be provided along the forming line so that multiple fiber layers may be formed along the same machine direction in a continuous process.

In some embodiments, rather than directly depositing the second fiber layer onto the first fiber layer, the first or second fiber layer may be formed on a separate wire (not shown in the figures), or may be pre-manufactured, and the two layers may be brought together after having been partially or completely consolidated.

Accordingly, methods described herein may be used to produce filter media having multiple fine fiber layers deposited on to a substrate. For example, multiple headboxes (e.g., for forming multi-ply or single-ply arrangements, pressure formers, etc.) may be located at appropriate positions along a machine or forming wire so that more than one fine fiber layer may be formed in a continuous manner and positioned on a suitable substrate. Alternatively, fine fiber layers may be separately formed (e.g., on separate forming wires/machines), apart from a continuous line process on a single machine/wire arrangement, and subsequently laminated, placed and/or adhered one on top of another. In each of these methods, multiple layers of the filter media are formed in a controlled manner where each of the layers may be subject to independent treatments and/or inclusion of one or more components without affecting other layers of the filter media.

In some embodiments, the exit velocity of slurry from the secondary headbox may be closely matched to the wire speed so as to reduce opportunities for any of the fiber layers to be disrupted as the upper fiber layer is deposited on to the lower fiber layer. The amount of intermixing between the layers (e.g., two or more fiber layers) may be controlled by adjusting flow characteristics of the secondary headbox, drainage rate, flow velocity and the use of suitable configurations of top formers and/or other vacuum boxes for upward and/or downward dewatering.

To further reduce the chances that contents between the two layers undesirably mix, the drainage rate in the forming area of the upper layer may be slowed, so as to provide less opportunity for contents from the lower layer to migrate upward into the upper layer.

Separation of the two layers may also be improved by pulping the fibers in a manner that is comparatively more gentle than conventional pulping processes. In some cases, using only a slight level of agitation, or a minimal amount of acid, to separate and disperse the fibers may be helpful to avoid undesirable fracturing or cutting of the fibers which may, in turn, lead to leakage of contents between fiber layers.

In some embodiments, if it is desired that the intermixing of the layers be further reduced, referring back to FIG. 1, an intermediate layer 30 can be added between the substrate 40 and the fine fiber layer 20. For example, the intermediate layer 30 may be added by providing an additional compartment in a multi-ply pressure former, or by providing an additional headbox to the system. In some embodiments, the intermediate layer 30 may be constructed of a fiber mixture that has a smaller mean fiber diameter than the substrate 40, but a larger mean fiber diameter then the fine fiber layer 20. In some embodiments, the intermediate ply 30 may be effective to capture small fibers and, thus, reduce the chances for fine fibers of the fine fiber layer to migrate into the substrate. Or, in some embodiments, the fine fiber layer may be provided between an intermediate layer and a substrate, for protection and improved durability.

The headbox flow rate and the drainage rate caused by vacuum formers downstream of the headbox may be appropriately adjusted to achieve a suitable ratio of thin stock velocity (e.g., velocity at which the slurry exits the headbox or pressure former) and wire speed. For instance, the velocity of the second fiber layer (e.g., to be formed as a fine fiber layer) may be adjusted by a combination of the headbox flow rate and the drainage rate to approximately match the speed of the first fiber layer (e.g., to be formed as a substrate layer). In some embodiments, the ratio of thin stock velocity to wire speed, or flow rate of the second fiber layer, is between 0.1 and 1.5, between 0.3 and 1.3, or between 0.8 and 1.2.

As discussed, components other than glass fibers may be incorporated into the furnish (e.g., before, during or after entry into a headbox or pressure former) for each of the respective layers of the filter media. In some embodiments, separate chemistries may be employed in formation of the substrate layer and the fine fiber layer. For example, with respect to the fine fiber layer, a fluorochemical composition and an organosilicon composition may be added to the fiber mixture before, during or after the headbox stage. Alternatively, with respect to the substrate layer, a binder composition may be added to the fiber mixture, also at any stage relative to the headbox, in addition to optionally including a fluorochemical composition and/or an organosilicon composition. As an example, a latex binder and a fluorocarbon (e.g., fluoroacrylate) may be provided to the substrate layer in order to exhibit pleatability, though, the latex binder may be kept separate from the fine fiber layer.

As discussed above, in some embodiments, fiber aggregates and contents therein are formed using a beater addition process, prior to entry into, or within, the headbox and/or pressure former. For example, the beater addition process may occur within a suitable compartment (e.g., pipe, container) prior to injection of the mixture into a headbox or pressure former. In such a process, fibers and various components (e.g., fluorochemical, organosilicon compositions) are added to water so as to form an aqueous slurry comprising a fiber mixture. Various components may include, for example, fluorochemical and/or organosilicon compositions, which may allow the fiber mixture to maintain a generally even consistency, as well as enhance gamma characteristics of the fiber web.

In a beater addition process, the fiber mixture may include a slurry containing various components to be incorporated into a fiber web, and may be subject to suitable agitation, for example, provided by rotating blades mounted on an axle-like shaft. The slurry may be agitated at an appropriate temperature, such as between about 50 F and about 150 F, or temperatures outside of this range. The slurry may be agitated for a suitable period of time so as to result in a desirable percentage of solids in the slurry, for example, between 1% and 10%. Various components may also be added to the batch one after another during constant agitation.

Flocculents or coagulants can be used, whether added in a pulper, holding chest, or added consistently to the fiber mixture, to form small flocs of short and/or thin fibers. Flocced fibers may generally have a low tendency to migrate into the base media (e.g., substrate layer) and, thus, may improve ply separation and overall performance of the filter media. In some embodiments, flocculents may serve to de-stabilize the binder composition, resulting in an agglomeration of particles (e.g., latex particles), which may further reduce migration of binder to the fine fiber layer.

In some embodiments, an electrostatic charge may be applied to the fiber mixture, for example, via the flocculent or coagulant. One or more ionic agents may be added to the fiber mixture, as a flocculent or coagulant, so as to impart an electrostatic charge to the fibers and/or other components of the fiber mixture. An ionic agent may be a cationic agent for imparting a net positive charge to the fiber mixture, or an anionic agent for imparting a net negative charge to the fiber mixture. For example, during a wet laid process, the ionic agent(s) may be added to a fiber mixture so as to cause the fibers and/or other components therein to exhibit a net positive or negative electrostatic charge, giving rise to a suspension with positively or negatively charged components.

In some embodiments, the ionic agent comprises at least one of modified starch, alum (e.g., aluminum sulfate, potassium aluminum sulfate), polyamine, polyamide, water soluble cationic multivalent salt, cationic modified starch, polyacrylamide, non-ionic polyethylene-oxide, cationic bentonite, aluminum phyllosilicate, cationic polyamine derivative, primary amine, methylamine, ethanolamine, secondary amine, dimethylamine, methylethanolamine, biguanide, cationic amino-silicon compound, cationic cellulose derivative, cationic starch, quaternary polyglycol amine condensate, quaternary collagen polypeptide, cationic chitin derivative, melamine-formaldehyde, cyclic amine, tertiary amine, trimethylamine, aziridine, piperidine, N-methylpiperidine, aniline, aromatic amine, diallyl dimethyl ammonium halide, quaternary ammonium salt, silver-amine-halide, quaternary amine, quaternary amide, quaternary imide, benzalkonium, colloidal silica, cationic guar gum, cationic polyamide-epichlorohydrin adduct, and combinations thereof. The agent may be highly ionic (e.g., cationic, anionic) and, thus, may impart an electrostatic charge to the fibers and other components. The agent may comprise a solvent including, for example, water, acetic acid, butanol, isopropanol, propanol, ethanol, methanol, formic acid, ethyl acetate, tetrahydrofuran, dichloromethane, acetone, acetonitrile, dimethylformamide, dimethyl sulfoxide, hexane, benzene, toluene, diethyl ether, chloroform, 1,4-dioxane, or combinations thereof. Other ionic agents may be used.

The ionic agent may be provided at any suitable weight percentage of the fiber mixture. In some embodiments, the ionic agent may be provided to the mixture that makes up the fine fiber layer, or the substrate layer, at a weight percentage of less than 5.0%, less than 3.0%, less than 2.0%, less than 1.0%, less than 0.5%, less than 0.1% by weight of the fiber layer. For example, the weight percentage of ionic agent provided to the fine fiber layer, or the substrate layer, may be between 0.01% and 5.0%, between 0.05% and 5.0%, between 0.1% and 5.0%, between 0.5% and 5.0%, between 1.0% and 5.0%, between 0.01% and 1.0%, between 0.05% and 1.0%, between 0.1% and 1.0%, or between 0.5% and 1.0% by weight of the fiber layer.

For a layer to be formed as a substrate, glass fibers, a binder composition and/or other components may be added to the furnish through the beater addition process. In some embodiments, as discussed above, it may be desirable that a substrate exhibit pleatability, which can be provided by inclusion of an appropriate binder composition (e.g., latex resin) to adhere to the fibers. Once an appropriate electrostatic charge is applied, and the desired isoelectric point of the fibers and other components of the mixture is reached, a suspension is created within the solvent (e.g., due to electrostatic repulsion).

For a layer to be formed as a fine fiber layer, fine glass fibers, a fluorochemical composition and/or an organosilicon composition may be combined and processed through a beater addition process, which may help to retain adherence of the fluorochemical and organosilicon composition(s) to the fibers. In some cases, although not all instances, for fiber mixtures that are provided as a precursor to forming the fine fiber layer (e.g., efficiency layer), the binder composition may be left out. The electrostatic charge is applied, as discussed above, and the fibers and components mixed therewith coagulate so as to form a suspension within the solvent (e.g., due to electrostatic repulsion).

In some embodiments, before the mixture is sent to a headbox (e.g., as a slurry), the mixture may be passed through centrifugal cleaners for removing unfiberized glass or shot. The mixture may or may not be passed through additional equipment such as refiners or deflakers to further enhance the dispersion of the fibers.

It can be appreciated that the methods described herein for forming the filter media and the individual layers of the filter media are not meant to be limiting. That is, portions of methods may be combined and/or modified in any suitable manner to produce filter media having favorable characteristics.

The filter media disclosed herein can be incorporated into a variety of filter elements for use in various applications including HEPA, ASHRAE, ULPA and other types of air filtration or purification. For example, the filter media may be used in heating and air conditioning ducts. The filter media may also be used in combination with other filters as a pre-filter, such as for example, acting as a pre-filter for high efficiency filter applications (e.g., HEPA). Filter elements may have any suitable configuration as known in the art including bag filters and panel filters.

The filter media may be used for a number of other applications, such as for pharmaceutical manipulation, medical applications (e.g., blood filtration), face masks, cabin air filtration, military garments, HVAC systems (e.g., for industrial areas and buildings), clean rooms, water/fuel separation, dehumidification wheels, batteries, ultra-capacitors, solar cells, or any other suitable application.

In some cases, the filter element includes a housing that may be disposed around the filter media. The housing can have various configurations, with the configurations varying based on the intended application. In some embodiments, the housing may be formed of a frame that is disposed around the perimeter of the filter media. For example, the frame may be thermally sealed around the perimeter. In some cases, the frame has a generally rectangular configuration surrounding all four sides of a generally rectangular filter media. The frame may be formed from various materials, including for example, cardboard, metal, polymers, or any combination of suitable materials. The filter elements may also include a variety of other features known in the art, such as stabilizing features for stabilizing the filter media relative to the frame, spacers, or any other appropriate feature.

As noted above, in some embodiments, the filter media can be incorporated into a bag (or pocket) filter element. A bag filter element may be formed by placing two filter media together (or folding a single filter media in half), and mating three sides (or two if folded) to one another such that only one side remains open, thereby forming a pocket inside the filter. In some embodiments, multiple filter pockets may be attached to a frame to form a filter element. Each pocket may be positioned such that the open end is located in the frame, thus allowing for air flow into each pocket. In some embodiments, a frame may include rectangular rings that extend into and retain each pocket. It should be appreciated that a frame can have virtually any configuration, and various mating techniques known in the art may be used to couple the pockets to the frame. Moreover, the frame may include any number of pockets, such as for example, between 6 and 10 pockets, which is common for bag filters.

In some embodiments, a bag filter may include any number of spacers disposed therein and configured to retain opposed sidewalls of the filter at a spaced distance apart from one another. Spacers can be threads or any other element extending between sidewalls. It can be understood that various features known in the art for use with bag or pocket filters can be incorporated into the filter media disclosed herein.

It should be understood that the filter media and filter elements may have a variety of different constructions and the particular construction depends on the application in which the filter media and elements are used.

During use, the filter media mechanically trap contaminant particles on the fiber web as fluid (e.g., air) flows through the filter media. The filter media need not be electrically charged to enhance trapping of contamination. Thus, in some embodiments, the filter media are not electrically charged. However, in some embodiments, the filter media may be electrically charged.

In some embodiments, the filter media may include water repellant properties. In other embodiments, the filter media does not include water repellant properties.

### EXAMPLES

The following examples are intended to illustrate certain embodiments of the present invention, but are not to be construed as limiting and do not exemplify the full scope of the invention.

In the examples, some filter media were made by forming hand sheets which is a technique known to those skilled in the art for producing filter media in small amounts (e.g., for testing/experimental purposes). Other filter media were made using a continuous in-line formation process similar to that described above.

### Examples 1-7

### Various Structural Arrangements

Examples 1-7 will now be described, which are filter media that are made for use in high efficiency HEPA applications. In each of these examples, the layers of the filter media were fabricated as hand sheets. Accordingly, each layer was produced on a lab bench top, where a fiber mixture containing an appropriate combination of components is added to a hand sheet mold. Once positioned in the hand sheet mold, the fiber mixture is dewatered by vacuum suction and subsequently dried by heat application, so as to form a layer. Once formed, each of the layers are placed in a suitable arrangement over one another to produce the filter media.

Examples 1-7 are described so as to demonstrate how gamma may be increased by progressively adding multiple fine fiber layers over a substrate. Table 1 shows the general composition of each of Examples 1-7, described in further detail below.

TABLE 1
Layered Structure Arrangement for Examples 1-7

| | | Layer 1 | | | | | Layer 6 |
|---|---|---|---|---|---|---|---|
| Example | Description | (Upstream) | Layer 2 | Layer 3 | Layer 4 | Layer 5 | (Downstream) |
| 1 | Conventional | Blend of fine | | | | | |
| | Fiber Blend | and coarse glass | | | | | |
| | | fibers | | | | | |
| 2 | Fine Fiber Layer | Fine fiber layer | Substrate | | | | |
| | on a Substrate | (0.2-0.25 mean | (glass fiber) | | | | |
| | | diameter) | | | | | |
| 3 | Two Fine Fiber | Fine fiber layer | Fine fiber layer | Substrate | | | |
| | Layers on a | (0.2-0.25 mean | (0.2-0.25 mean | (glass fiber) | | | |
| | Substrate | diameter) | diameter) | | | | |
| 4 | Two Fine Fiber | Fine fiber layer | Fine fiber layer | Substrate | | | |
| | Layers on a | (0.2-0.25 mean | (0.4 mean | (glass fiber) | | | |
| | Substrate | diameter) | diameter) | | | | |
| 5 | Two Fine Fiber | Substrate | Fine fiber layer | Fine fiber layer | Substrate | | |
| | Layers between | (glass fiber) | (0.2-0.25 and 0.6 | (0.2-0.25 mean | (glass fiber) | | |
| | two Substrates | | mean diameter) | diameter) | | | |
| 6 | Four Fine Fiber | Substrate | Fine fiber layer | Fine fiber layer | Fine fiber layer | Fine fiber layer | Substrate |
| | Layers between | (PET synthetic | (0.2-0.25 mean | (0.4 mean | (0.2-0.25 mean | (0.2-0.25 mean | (glass fiber) |
| | two Substrates | fiber) | diameter) | diameter) | diameter) | diameter) | |
| 7 | Four Fine Fiber | Substrate | Fine fiber layer | Fine fiber layer | Fine fiber layer | Fine fiber layer | Substrate |
| | Layers between | (PET synthetic | (0.2-0.25 mean | (0.4 mean | (0.2-0.25 mean | (0.2-0.25 mean | (glass fiber) |
| | two Substrates | fiber) | diameter) | diameter) | diameter) | diameter) | |

Example 1 is a conventional filter media that includes a blend of glass microfibers and chopped strand fibers. A binder resin was incorporated in the filter media of Example 1, however, for Examples 2-7, no binder resin was included.

In Example 2, a single fine fiber layer was deposited on a substrate. The fine glass fibers of the fine fiber layer were Johns Mansville (JM) Code 90 fine glass fibers, having a nominal mean diameter of 0.2-0.25 microns. The substrate was a pre-made JM B-20 glass fiber backing material.

In Examples 3 and 4, two fine fiber layers were deposited on a substrate. For Example 3, the fine glass fibers of both fine fiber layers were JM Code 90 fine glass fibers, having a mean diameter of 0.2-0.25 microns; while in Example 4, the fine glass fibers of one of the fine fiber layers were JM Code 90 fine glass fibers, having a mean diameter of 0.2-0.25 microns, and the fine glass fibers of the other fine fiber layer were JM 104 fine glass fibers, having a mean diameter of 0.4 microns. The substrate for each of Examples 3 and 4 was a pre-made JM B-20 glass fiber backing material.

Example 5 is a four layer filter media including two fine fiber layers and two substrate layers. The two fine fiber layers were sandwiched between the two substrate layers. That is, the substrate layers were located on the outside of the filter media—one substrate layer on the downstream side and the other substrate layer on the upstream side of the filter media. The fine glass fibers of one of the fine fiber layers were a 50/50 mix of JM Code 90 fine glass fibers, having a mean diameter of 0.2-0.25 microns, and JM 106 fiber, having a mean diameter 0.6 microns. The fine glass fibers of the other fine fiber layer were JM Code 90 fine glass fibers, having a mean diameter of 0.2-0.25 microns. Both of the substrates (upstream and downstream) for the filter media of Example 5 were pre-made JM B-20 glass fiber backing materials.

Examples 6 and 7 are each a six layer filter media including four fine fiber layers and two substrate layers. The four fine fiber layers were located between the two substrate layers. Similar to Example 5, one substrate layer was located on the downstream side and the other substrate layer was located on the upstream side of the filter media. In each of Examples 6 and 7, the fine glass fibers for three of the fine fiber layers were JM Code 90 fine glass fibers, having a mean diameter of 0.2-0.25 microns; the fine glass fibers for the fourth fine fiber layer was JM 104 fine glass fibers, having a mean diameter of 0.4 microns. Also, in each of Examples 6 and 7, the upstream substrate was a Reemay 2250 scrim including PET nonwoven backing material having a basis weight of 15 gsm; and the downstream substrate was a JM B-20 glass fiber pleatable backing material. While the filter media of Examples 6 and 7 had the same composition of layers, the filter media of Example 7 was formed under a reduced vacuum so as to reduce overall solidity (e.g., increase consistency) of the filter media.

The measured gamma characteristics, including pressure drop and penetration, for each of Examples 1-7 are listed in Table 2, provided below.

TABLE 2
Gamma characteristics for Examples 1-7

| | | Pressure | Penetration | |
|---|---|---|---|---|
| | | drop | (@0.12 microns, | Gamma |
| Exam- | | (@5.3 cm/s, | 2.5 cm/s | (mm |
| ple | Description | mm H₂O) | velocity, %) | H₂O⁻¹) |
| 1 | Conventional Fiber | 27.0 | 0.02 | 13.7 |
| | Blend | | | |
| 2 | Fine Fiber Layer on | 17.2 | 0.139 | 16.6 |
| | a Substrate | | | |
| 3 | Two Fine Fiber | 18.7 | 0.064 | 17.1 |
| | Layers on a | | | |
| | Substrate | | | |
| 4 | Two Fine Fiber | 15.5 | 0.205 | 17.3 |
| | Layers on a | | | |
| | Substrate | | | |
| 5 | Two Fine Fiber | 19.1 | 0.0287 | 18.6 |
| | Layers between two | | | |
| | Substrates | | | |
| 6 | Four Fine Fiber | 19.0 | 0.026 | 18.9 |
| | Layers between two | | | |
| | Substrates | | | |
| 7 | Four Fine Fiber | 20.1 | 0.0126 | 19.4 |
| | Layers between two | | | |
| | Substrates | | | |

The gamma value of the filter media of Examples 2-7 were observed to be higher than the gamma value of the filter media of Example 1, evidencing that including a fine fiber layer on a substrate yields better performance characteristics than does a conventional fiber blend.

Further, gamma values were observed to be higher for filter media that incorporate greater numbers of individual fine fiber layers. For instance, the filter media of Examples 3 and 4, including two fine fiber layers, were observed to have higher gamma values, 17.1 and 16.6, respectively, than the gamma value of 16.6 for the filter media of Example 2, which included a single fine fiber layer.

In addition, gamma values were also observed to be higher for filter media that included substrates on both the upstream side and the downstream side of the filter media. As shown in Table 2, the filter media for Example 5, which had substrates located on opposite upstream and downstream sides, exhibited a higher gamma, 18.6, than the filter media of Examples 3 and 4, which had only one substrate, located on the upstream side. It was also observed that substrates located on opposite sides of the filter media also serve to protect the fine fiber layers, affording the filter media longer life.

The filter media of Examples 6 and 7, each of which had four fine fiber layers located between two oppositely positioned substrates, were observed to exhibit even higher gamma values, 18.6 and 19.4, respectively.

Further, the effects of processing of the filter media of Example 7 to reduce overall solidity (i.e., by adjusting the vacuum power during dewatering) of the filter media were observed to further enhance gamma, as compared with the filter media of Example 6.

### Example 8

### Gamma vs. Average Fiber Diameter

Here, the effect of the average diameter of a fine fiber layer within the filter media on gamma of the filter media was studied. In this Example, four different filter media were made. Each filter media included a single fine fiber layer having a particular average fiber diameter placed on a JM B-20 backer substrate. The respective single fine fiber layers included JM 90 fibers having a nominal average diameter of 0.25 microns, JM 100 fibers having a nominal average diameter of 0.30 microns, Lauscha B-02 fibers having a nominal average diameter of 0.35 microns, and Lauscha B-04 fibers having a nominal average diameter of 0.40 microns.

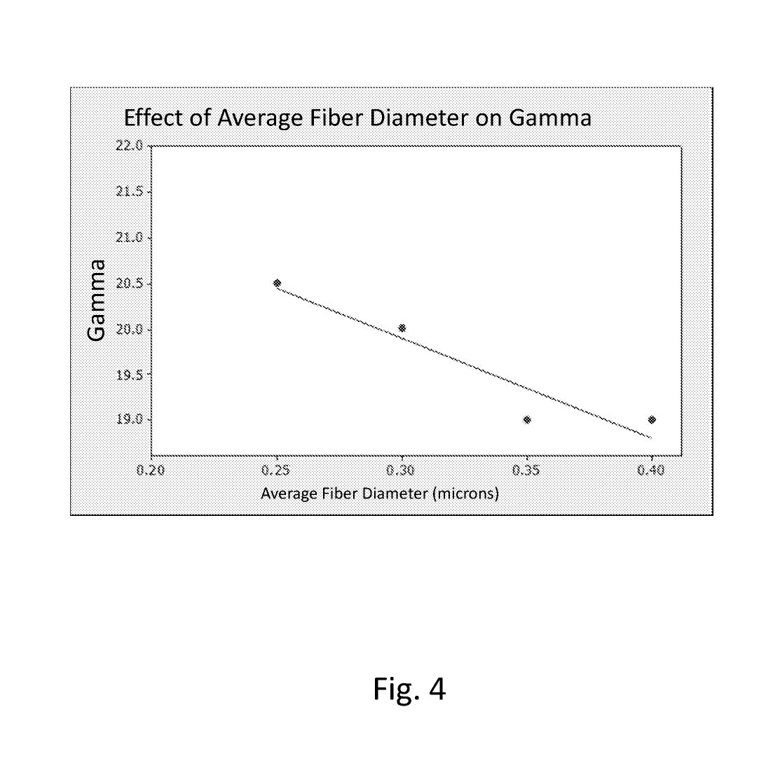

FIG. 4 shows that gamma was observed to generally increase for filter media incorporating smaller fiber diameters within the fine fiber layer. For example, a filter media that included a fine fiber layer having an average fiber diameter of 0.25 microns was observed to have a gamma of approximately 20.5. On the other hand, a filter media that included a fine fiber layer having an average fiber diameter of 0.4 microns was observed to have a gamma of approximately 19.0.

### Examples 9-11

### Further Structural Arrangements

In Example 9, a filter media, made for use in lower efficiency ASHRAE applications, was composed of three separately formed layers, fabricated in a wet laid process. This example was formed using a process in accordance with methods described herein.

In the process for forming the filter media of Example 9, each of the fiber layers of the filter media were formed along the same continuous line, which employed a primary headbox and a secondary headbox, similar to that shown in FIGS. 3a-3d. However, in these examples, the primary headbox was also configured for two separate fiber mixture flows, similar to that shown in FIGS. 2a-2d, where a lamella allows for separate and simultaneous formation of the first and second layers.

In Example 9, the fibers of the first layer were coarse chopped strand glass fibers obtained from PPG. These fibers had a nominal length of approximately 6 mm and a nominal diameter of approximately 6 microns. The first layer was produced through one of the compartments of the primary headbox. The basis weight of the first layer, after being dried, was 60-70 gsm.

The fibers of the second layer were coarse glass fibers (JM 112 glass fibers). These fibers had a nominal diameter of approximately 2.5-3.5 microns. The second layer was produced via the other compartment of the primary headbox. The basis weight of the second layer, after drying, was 10-15 gsm.

The third layer also includes fine glass fibers (JM 106 glass fibers), processed via the secondary headbox. These fibers had a nominal diameter of approximately 0.6-0.65 microns. The basis weight of the third layer, after drying, was 5-10 gsm.

In forming the third layer, fluorocarbon and polysiloxane were both added to the fine glass fibers in the secondary headbox. When the fiber mixture corresponding to the third layer exited the secondary headbox, the fiber mixture was positioned over the first and second layers, and then subject to downward vacuum dewatering. Accordingly, both fluorocarbon and polysiloxane from the third layer were allowed to migrate down from the third layer and through each of the first and second layers. In this example, the fluorocarbon and polysiloxane combined together made up 1% by weight of the filter media and the fibers made up 99% by weight of the filter media.

For Example 9, gamma was measured to be between approximately 17-18, using methods of measuring initial pressure drop and penetration values described above. In particular, the initial pressure drop was measured to be 5.1 mm H₂O and the initial penetration of the filter media was measured to be 13.5%. The dust holding capacity of the filter media of Example 9 was measured to be between approximately 50-60 g/m², measured using the methods described above, up until the pressure across the filter media reached 375 Pa. By way of comparison, a standard single layer filter media is estimated to have a dust holding capacity of between 20-25 g/m², and a dual layer filter media, for an equivalent penetration, is estimated to have a dust holding capacity of between 30-35 g/m². In general, a longer life is expected for filter media that exhibit higher dust holding capacities.

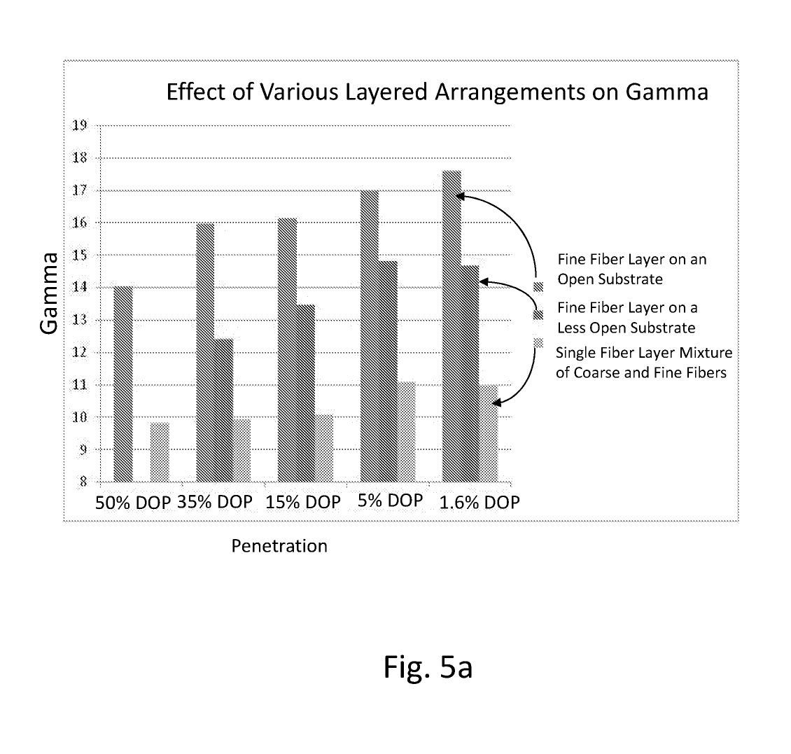

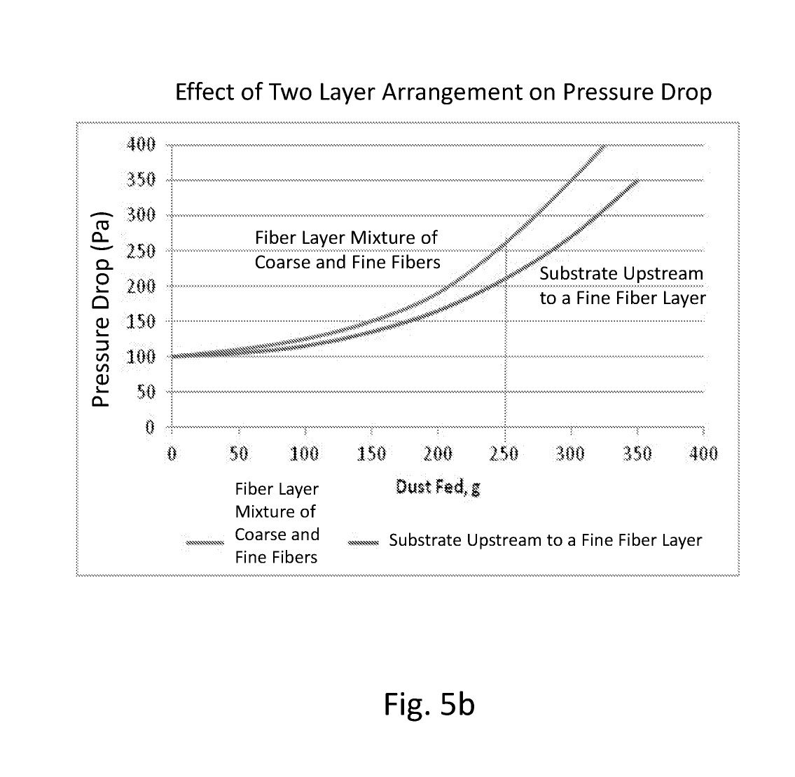

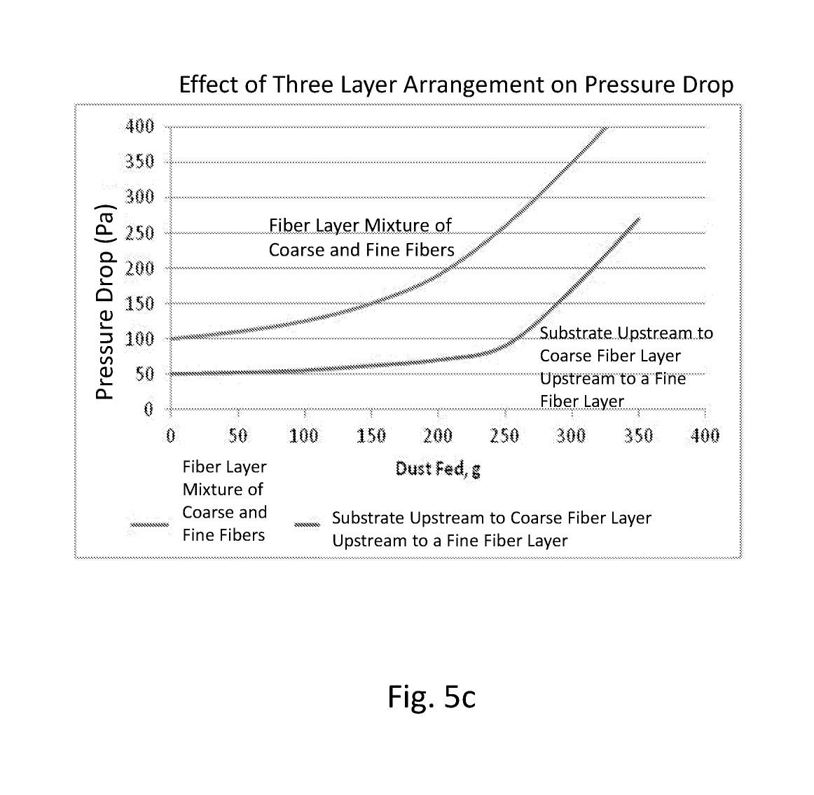

For Example 10, FIG. 5a shows a graph that depicts various gamma values for different filter media arrangements that were made for different efficiency levels. Several distinct efficiency levels of filter media are displayed, ranging from generally low efficiency to sub-HEPA efficiency levels. More specifically, the efficiency levels for each type of filter media are 50%, 65%, 85%, 95% and 98.4%, using the DOP penetration testing described above.

For each level of efficiency, three types of filter media were produced: 1) a single fiber layer incorporating a blend of fine glass fibers (JM 106 fibers) and coarse glass fibers (JM 112 fibers); 2) a fine fiber layer between 3-10 gsm, with fine glass fibers having an average diameter of 0.3-0.6 microns (obtained from Lauscha Fiber International; for 50% DOP, 35% DOP and 15% DOP efficiencies, B-06 glass fibers having an average fiber diameter of 0.6 microns; for 5% DOP efficiency, B-04 glass fibers having an average fiber diameter of 0.4 microns; and for 1.6% DOP efficiency, B-02 glass fibers having an average fiber diameter of 0.35 microns), adhered on a pleatable substrate, which is a pre-made glass/PET synthetic fiber backer between 60-65 gsm, without binder, where the entire filter media was impregnated with a mix of acrylic binder, fluorocarbon and polysiloxane resins; and 3) a fine fiber layer between 3-10 gsm, with fine glass fibers having an average diameter of 0.3-0.6 microns (same fibers obtained from Lauscha Fiber International described with respect to filter media type 2)), adhered on an open pleatable substrate, which is a pre-made pleatable glass fiber backer (JM B-20) without binder, where the entire filter media was impregnated with a 1% solution of fluorocarbon polymer in water. The open substrate of filter media type 3) exhibits little to no pressure drop when subject to the above-described penetration test, while the substrate of filter media type 2) is less open and exhibits a pressure drop of approximately 10 Pa when subject to the penetration test.

As shown, for each efficiency level grouping, the measured gamma values for the filter media comprising a single blended fiber layer, having fine fibers and coarse fibers, was the lowest, while the measured gamma values for the filter media comprising the fine fiber layer disposed on the open substrate (giving rise to a low pressure drop) was the highest.

For Example 11, FIG. 5b is a graph that shows a comparison between dust fed vs. pressure drop for two different filter media. One of the filter media is a single fiber layer including a mixture of fine glass fibers (JM 106 fibers) and coarse glass fibers (JM 112 fibers), having a basis weight of 70-80 gsm. The other filter media includes a 10 gsm fine fiber layer (JM 106) disposed on a substrate. The substrate was 65 gsm and was disposed upstream relative to the fine fiber layer, and comprises 30% by weight coarse glass fibers (JM 112 fibers) and 70% by weight PET fibers. As shown, as dust is loaded into the media, the pressure drop rises at a slower rate for the dual layer filter media than for the single layer filter media. Accordingly, for a given level of dust fed toward the filter media, the dual layer arrangement is observed to exhibit a lower pressure drop (i.e., permitting fluid flow through the media), which corresponds to an increase in gamma as compared to the single layer arrangement without the substrate.

Also related to Example 11, the effect of having multiple layers is even more pronounced in the graph shown in FIG. 5c, which shows the same characteristic graph of FIG. 5b except the comparison is between the single fiber layer including a mixture of fine glass fibers (JM 106 fibers) and coarse glass fibers (JM 112 fibers), and the three layer filter media arrangement of Example 9, including a substrate disposed upstream to a coarse fiber layer which is, in turn, disposed upstream to a fine fiber layer.

Here, for a given amount of dust fed toward the filter media, the pressure drop is further reduced, leading to correspondingly greater gamma values.

### Examples 12-15

### Effects of Fluorocarbon and Polysiloxane

The effects of adding fluorocarbon and polysiloxane to a fine glass fiber media were studied in Examples 12-15. In these examples, 1.5 grams of fine glass fibers (JM 108A fibers) were blended with 20 mL of H₂SO₄ added to 1 L of water for 30 seconds. A 12″×12″ scrim (Reemay 2250) was placed on top of a forming wire and a hand sheet mold was filled with water. The fiber mixture was added to the hand sheet mold over the scrim and drained by gravity, forming the fiber on to the scrim. The formed fiber mixture on the scrim was then dried through a vacuum slot before applying a fluorocarbon/polysiloxane (FC/Si) coating to the entire filter media. The filter media was then vacuum dried again before drying on a photo dryer at approximately 80 C.

In Example 12, no FC/Si coating was provided to the formed filter media. In Example 13, the filter media was dip coated in a 1 liter aqueous dispersion that included 0.5 grams (dry weight) of an amino functional silicone. In Example 14, the filter media was dip coated in a 1 liter aqueous dispersion that included 0.5 grams (dry weight) of amino functional silicone and 2.0 grams (dry weight) of a fluoroacrylate. For Examples 13 and 14, after coating, each filter media was then vacuumed and dried.

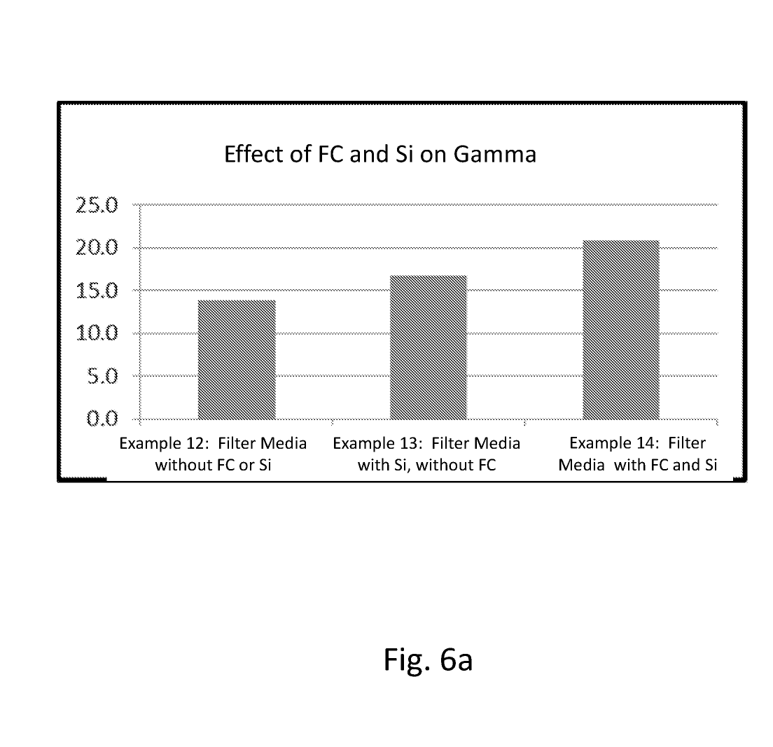

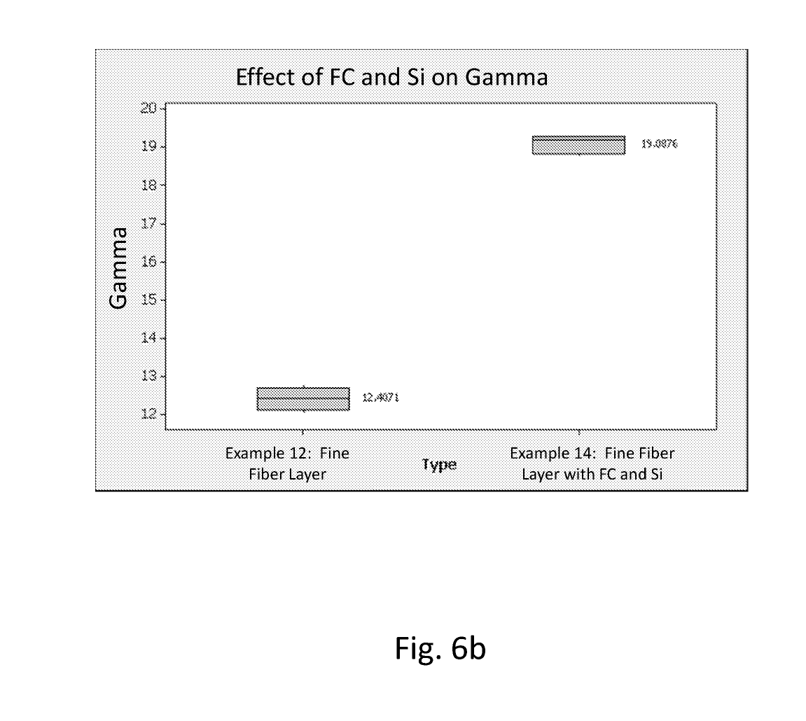

FIG. 6a illustrates a graph that shows the measured gamma values corresponding to filter media that are coated and uncoated with the FC/Si formulation, in accordance with Examples 12-14. The filter media of Example 14, coated with the combined FC/Si formulation, was shown to exhibit a greater gamma value, approximately 20.5, than that of the filter media of Example 12 (gamma of approximately 14.0), which was uncoated with the FC/Si formulation. It was observed that Example 14 also exhibited a greater gamma value than the filter media of Example 13 (gamma of approximately 16.5), which was only coated with amino functional silicone, without fluoroacrylate.

FIG. 6b depicts a graph that shows the measured gamma value for only the fine fiber layer of Examples 12 and 14, without the scrim. This graph demonstrates that the addition of fluorocarbon and polysiloxane to the fine fiber layer, absent the substrate, enhances gamma of the fine fiber layer. As shown, the gamma value of the filter media of Example 14 was observed to be approximately 19.1, whereas the gamma value of the filter media of Example 12 was observed to be approximately 12.4.

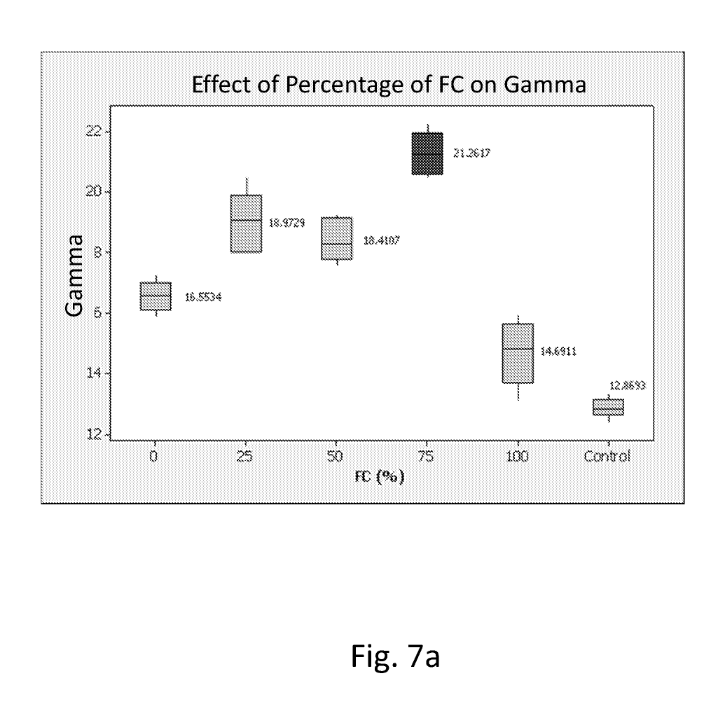

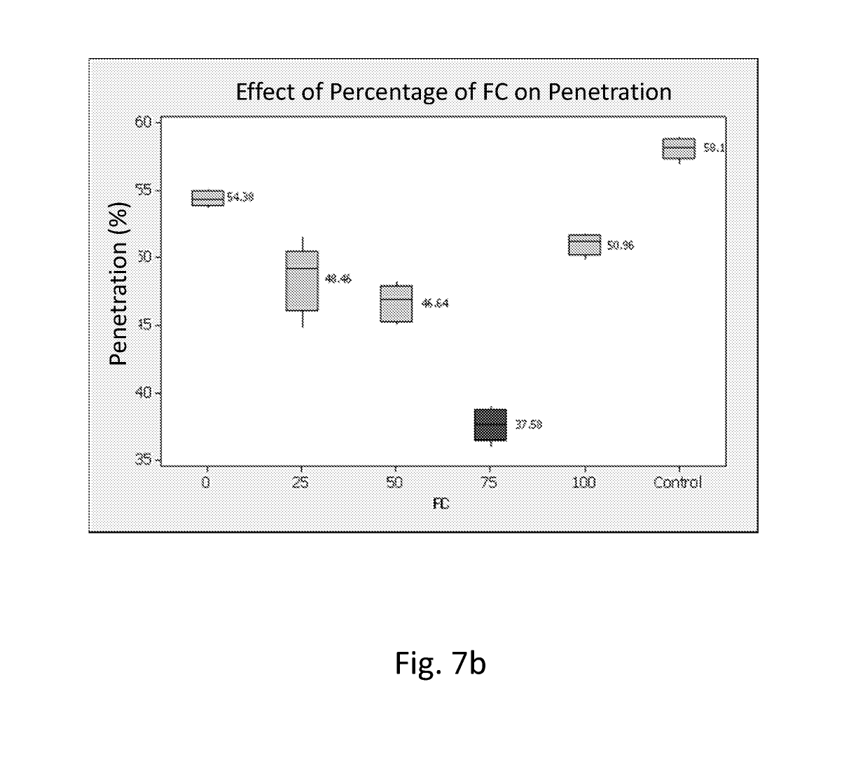

The effect of the FC:Si ratio was also studied for filter media produced in Example 15, as shown in FIGS. 7a-7b. In the examples provided above where fluorocarbon and polysiloxane are both incorporated, the FC:Si ratio was 80:20, however, for the filter media of Example 15, gamma and penetration values were measured for filter media where the FC:Si ratio was varied.

For Example 15, hand sheets were made according to methods described in Examples 1-7. In this example, 0.8 grams of fine glass fibers (JM 108 glass fibers, having an average diameter of 0.8 microns) was used and the following percentage ratios of FC:Si were mixed with the fine glass fibers: 0:100, 25:75, 50:50, 75:25 and 100:0. The ratios of fluorocarbon and polysiloxane were based on a total dry solids weight of 2.5 g/l, which was used for each of the samples. A control was also prepared, having no fluorocarbon or polysiloxane. The fine fiber layer was adhered to a polyester substrate (Reemay 2004 Polyester scrim).

As shown in FIG. 7a, the presence of fluorocarbon or polysiloxane alone within the respective filter media was shown to enhance gamma, comparing filter media having only a FC coating (100% FC) or only a Si coating (0% FC) to the control filter media (absent FC and Si); however, a filter media including both the fluorocarbon and polysiloxane together yielded even better gamma results.

As further shown, the ratio of FC:Si within the filter media that results in the highest gamma value for the filter media is a FC:Si of approximately 75:25.

FIG. 7b further shows that one factor that contributed to the observed increase in gamma is that the penetration percentage of the filter media was substantially reduced for filter media coated with a FC:Si ratio of 75:25. This observation indicates that the filter media coated with the appropriate blend of fluorocarbon and polysiloxane was more efficient in capturing dust particles as compared to pure mechanical filter media without the fluorocarbon and/or polysiloxane.

### Example 16

### High Gamma and Mechanical Properties

In another example, a filter media for use in HVAC applications was made, employing a pre-made glass scrim (OC B5a from Owens Corning) and a fine fiber layer (composed of Lauscha B-10 fibers, having a nominal average diameter of 1.0 micron) laid over the scrim. The filter media, including fine fiber layer and glass scrim, was also saturated with fluorocarbon and polysiloxane at a fluorocarbon:polysiloxane ratio of 3:1.

Using test methods described above, the filter media was measured for gamma as well as stiffness and machine direction tensile strength. The gamma was observed to be 17.2, the stiffness, measured in the machine direction, was observed to be 1000 gu, and the machine direction tensile strength was observed to be 2.7 kN/m (15.5 lb/inch). In comparison, some conventional HVAC filter media having acceptable mechanical properties, such as a MD tensile strength of 1 kN/m and a stiffness of 700 gu, exhibit a lower value of gamma, typically 10 or less.

Accordingly, the filter media of Example 16 is made up of two layers, a substrate and a fine fiber layer, and exhibits a unique combination of high gamma with advantageous mechanical properties (i.e., high stiffness and tensile strength).

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A filter media, comprising:
a substrate;
a first layer comprising a plurality of glass fibers, wherein at least 70% by weight of the plurality of glass fibers within the first layer have a fiber diameter of less than 2 microns; and
a second layer comprising a plurality of glass fibers, wherein at least 70% by weight of the plurality of glass fibers within the second layer have a fiber diameter of less than 2 microns.

2. The filter media of claim 1, wherein the first layer or the second layer comprises a fluorochemical composition or an organosilicon composition.

3. The filter media of claim 2, wherein the first layer or the second layer comprises a fluorochemical composition and an organosilicon composition.

4. The filter media of claim 3, wherein the first layer or the second layer comprises a ratio of fluorochemical composition to organosilicon composition of between 5:1 and 2:1.

5. The filter media of claim 1, wherein the first layer or the second layer optionally includes a binder composition, wherein the binder composition comprises 0% to 2% by weight of the first layer or the second layer.

6. The filter media of claim 5, wherein the first layer or the second layer is substantially free of the binder composition.

7. The filter media of claim 1, wherein the plurality of glass fibers within the first layer or the second layer has an average fiber diameter of less than 1 micron.

8. The filter media of claim 1, further comprising an additional layer separately formed from the first layer and the second layer.

9. The filter media of claim 1, further comprising an additional substrate, wherein the first layer and the second layer are disposed between the substrate and the additional substrate.

10. The filter media of claim 9, wherein the substrate or the additional substrate is located on an upstream side of the filter media and the other substrate is located on a downstream side of the filter media.

11. The filter media of claim 1, wherein the filter media exhibits a gamma of greater than 7 when subject to a penetration test using particles having a size of approximately 0.12 microns traveling at a face velocity of approximately 2.5 cm/sec.

12. The filter media of claim 1, wherein the filter media exhibits a gamma of greater than 7 when subject to a penetration test using particles having a size of approximately 0.3 microns traveling at a face velocity of approximately 5.3 cm/sec.

13. The filter media of claim 1, wherein the filter media exhibits a dust holding capacity of greater than 10 g/m².

14. The filter media of claim 1, wherein, the filter media exhibits an efficiency of greater than 99% when subject to a penetration test using particles having a size of approximately 0.12 microns traveling at a face velocity of approximately 2.5 cm/sec.

15. The filter media of claim 1, wherein the filter media exhibits an initial pressure drop of less than 200 mm H₂O.

16. A filter media, comprising:
a substrate;
a first layer comprising a plurality of glass fibers having an average fiber diameter of less than 2 microns; and
a second layer comprising a plurality of glass fibers having an average fiber diameter of less than 2 microns.
